(19) United States
(12) Patent Application Publication
(10) Pub. No.: US 2026/0322575 A1
(43) Pub. Date: Oct. 15, 2026

(54) DUAL MODE PHR REPORTING FOR SBFD CAPABLE UES

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed IBRAHIM, San Diego, CA (US); Mohammed JABI, San Diego, CA (US)

(21) Appl. No.: 19/178,772

(22) Filed: Apr. 14, 2025

(51) Int. Cl. H04L 5/14

(52) U.S. Cl. CPC H04L 5/14

(57) ABSTRACT

The apparatus may be a wireless device configured to receive configuration information associated with a report indicating a maximum uplink power (Pₘₐₓ) associated with a full duplex (FD) mode of operation at the UE and transmit, to a network device, the report, wherein the report comprises a set of values comprising a Pₘₐₓ value associated with the FD mode of operation at the UE. The apparatus may be a network device configured to transmit, to a user equipment (UE) that supports an FD mode of operation, configuration information associated with a report indicating a Pₘₐₓ associated with the FD mode of operation at the UE and receive, from the UE, the report, wherein the report comprises a set of values comprising a Pₘₐₓ value associated with the FD mode of operation at the UE.

### TECHNICAL FIELD

The present disclosure relates generally to communication systems, and more particularly, to a wireless communication associated with a full-duplex capable wireless device.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to receive configuration information associated with a report indicating a maximum uplink power (Pₘₐₓ) associated with a full duplex (FD) mode of operation at the UE, and transmit, to a network device, the report, wherein the report comprises a set of values comprising a Pₘₐₓ value associated with the FD mode of operation at the UE.

In an aspect of the disclosure, a method, a computer-readable medium, and an apparatus are provided. The apparatus may be a network device such as a base station configured to transmit, to a UE that supports an FD mode of operation, configuration information associated with a report indicating a Pₘₐₓ associated with the FD mode of operation at the UE, and receive, from the UE, the report, wherein the report comprises a set of values comprising a Pₘₐₓ value associated with the FD mode of operation at the UE.

an FDan FDan FDTo the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates a first example and a second example of in-band full-duplex (IBFD) resources and a third example of SBFD resources.

FIG. 5A is a diagram illustrating an example of a resource allocation for a SBFD operation.

FIG. 5B is a diagram illustrating two UEs (e.g., UE 1 522 and UE 2 524) operating in a half-duplex mode of operation.

FIG. 5C is a diagram illustrating a first UE (e.g., UE 1 542) operating in a half-duplex mode of operation and a second UE (e.g., UE 2 544) operating in a full-duplex, or SBFD, mode of operation.

FIG. 6A is a diagram illustrating a first example of a maximum transmit power calculated based on interference.

FIG. 6B is a diagram illustrating a second example of a maximum transmit power calculated based on interference.

FIG. 7A illustrates an example PHR MAC-CE for reporting a single and a PH.

FIG. 7B is a diagram illustrating an example PHR MAC-CE (e.g., an example PHR MAC-CE structure/format) used to transmit PHR information for a dual-mode PHR reporting including an additional value.

FIG. 7C is a diagram illustrating an example PHR MAC-CE (e.g., an example PHR MAC-CE structure/format) used to transmit PHR information for a dual-mode PHR reporting including an additional PH value and an additional value.

FIG. 7D is a diagram illustrating an example PHR MAC-CE (e.g., an example PHR MAC-CE structure/format) used to transmit PHR information for a current mode of SBFD operation.

FIG. 8A is a diagram illustrating an example PHR MAC-CE (e.g., an example PHR MAC-CE structure/format) used to transmit PHR information for a TDD mode of operation, an HD mode of SBFD operation, and an FD mode of SBFD operation.

FIG. 8B is a diagram illustrating an example PHR MAC-CE (e.g., an example PHR MAC-CE structure/format) used to transmit PHR information for a TDD mode of operation, an HD mode of SBFD operation, and an FD mode of SBFD operation.

FIG. 9 is a diagram illustrating an example PHR MAC-CE (e.g., an example PHR MAC-CE structure/format) used to transmit PHR information for a TDD mode of operation, an HD mode of SBFD operation, and an FD mode of SBFD operation that may be used for PHR reporting for multiple serving cells and/or TRPs.

FIG. 10 is a call flow diagram illustrating a method of wireless communication in accordance with some aspects of the disclosure.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an apparatus.

FIG. 16 is a diagram illustrating an example of a hardware implementation for a network entity.

### DETAILED DESCRIPTION

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time, may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. As one example, full duplex operation may enable a base station to transmit a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

There may be various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication.

In some aspects, a first base station may transmit and receive full duplex communication with a first UE and a second UE that transmit or receive half-duplex communication in a half-duplex mode. In some aspects, a base station may transmit and receive full-duplex communication with a UE that operates in a full-duplex mode. Full duplex communication may be in the same frequency band. The uplink and downlink communication may be in different frequency sub-bands, in the same frequency sub-band, or in partially overlapping frequency sub-bands.

A UE, in some aspects, may report a maximum transmit power (a P_{cmax,f,c} for a carrier frequency f and a cell c, which may be referred to as a P_{cmax} where the dependency on the carrier frequency and the cell is not specifically relevant to the discussion) and a power headroom (PH) indicating a difference between the reported maximum transmit power and a current transmission power. The maximum transmit power, in some aspects, may be dependent on a noise and/or interference level. A UE operating in a half-duplex mode of operation may experience interference for a DL reception based on transmissions from other devices (e.g., cross-link interference (CLI), cross-channel interference (CCI), intra-cell-interference from UL transmissions from other UEs in a same cell, or inter-cell interference from UL or DL transmissions transmitted by devices associated with a different cell, which may be referred to collectively as external interference), where the P_{cmax} may not account for the interference as the UL transmission in a HD mode of operation is unrelated to the DL reception at the UE. A UE operating, or capable of operating, in the SBFD mode of operation (which may be referred to as a SBFD-capable UE), may experience the external interference for a DL reception based on the transmissions from other devices as described above and may additionally experience interference from its own UL transmissions (e.g., a self-interference (SI) for a DL reception in a first DL frequency sub-band in a set of SBFD resources based on a simultaneous UL transmission in a second, different UL frequency sub-band in the set of SBFD resources). The SI experienced at the UE may be a residual SI after a local SI mitigation. Based on the additional interference, a first maximum transmit power (e.g., a P_{cmax} or a P_{cmax,HD}) calculated for the HD mode of operation may be different from a second maximum transmit power (e.g., a P_{cmax} or a P_{cmax,SBFD}) calculated and/or selected for the SBFD mode of operation based on a measured interference (e.g., a combination of the external interference and (residual) SI). For example, the P_{cmax} may be selected by the UE from a range based on a lower bound (e.g., P_{cmax_L}) and an upper bound (e.g., P_{cmax_H}) such that P_{cmax_L}≤P_{cmax}≤P_{cmax_H}. The calculation of the P_{cmax_H} may not be based on the interference experienced by the UE, while the calculation of the P_{cmax_L} may be based on the interference by introducing a new maximum power reduction term (e.g., MPR_{SBFD}).

In some aspects, the P_{cmax,f,c} and the PH may be included in a PH report (PHR). A PHR may be one of a plurality of types. For example, a first type, or Type 1, PH or PHR may be associated with a physical uplink shared channel (PUSCH) (e.g., a PUSCH-only transmission on the carrier), a second type, or Type 2, PH or PHR may be associated with a PUSCH and a physical uplink control channel (PUCCH), and third type, or Type 3, PH or PHR may be associated with a sounding reference signal (SRS) not associated with a PUSCH. The PHR may be based on an actual transmission (e.g., a PUSCH, a PUSCH and PUCCH, or SRS transmission) or a reference transmission and/or format based on higher layer (e.g., radio resource control (RRC)) signaling of one of a configured grant and/or periodic/semi-persistent PDCCH monitoring occasion. In some aspects, the method of calculating the PH may depend on the type of PH and/or PHR being reported and whether the PH is based on an actual transmission or a reference transmission. The PHR may further depend on higher layer signaling of configured grant, and/or periodic/semi-persistent, sounding reference signal transmissions and downlink control information (DCI) received by a reporting UE in a given period which may be based on whether the PHR will be reported in PUSCH scheduled by a DCI or a CG-PUSCH.

The higher layer signaling may indicate a plurality of parameters for a PHR transmitted, for example, in a medium access control (MAC) control element (CE) (MAC-CE). The parameters may include a first timer for triggering a PHR report (e.g., phr-PeriodicTimer), where the first timer controls the periodicity of PHR reporting such that when the first timer expires, a PHR is triggered, a second timer for preventing subsequent PHR reporting (e.g., a phr-ProhibitTimer) that prevents the UE from reporting PHR too frequently such that before the expiration of the second timer PHR reporting may be prohibited. Other parameters include a first format parameter indicating whether to use a Multiple Entry PHR MAC CE or a Single Entry PHR MAC CE, and a second format parameter indicating if power headroom should be reported as two PHRs, each associated with an SRS (Sounding Reference Signal) resource set.

Various aspects relate generally to extending a PHR or P_{cmax} reporting for a UE (e.g., a SBFD-capable UE) that supports operation in different HD modes of operation (e.g., associated with TDD or SBFD slots and/or symbols) or an FD mode of operation (e.g., associated with SBFD slots and/or symbols). Some aspects more specifically relate to new formats and/or configurations for signaling associated with PHR or P_{cmax} reporting including an indication of a PH or P_{cmax} (where P_{cmax} may be referred to as Pₘₐₓ for simplicity) for each of a HD mode of operation and a SBFD mode of operation at the UE. In some examples, a wireless device may be configured to receive configuration information associated with a report indicating a Pₘₐₓ associated with an FD mode of operation at the UE, and transmit, to a network device, the report, wherein the report comprises a set of values comprising a Pₘₐₓ value associated with the FD mode of operation at the UEan FD. In some examples, a network device may be configured to transmit, to a UE that supports an FD mode of operation, configuration information associated with a report indicating a Pₘₐₓ associated with the FD mode of operation at the UE, and receive, from the UE, the report, wherein the report comprises a set of values comprising a Pₘₐₓ value associated with the FD mode of operation at the UEan FD. In some examples, a wireless device may be configured to receive configuration information associated with a report indicating a first Pₘₐₓ associated with the FD mode of operation at the UE and a second Pₘₐₓ associated with a HD mode of operation at the UE, and transmit, to a network device, the report, wherein the report comprises a set of values comprising a first value associated with a maximum uplink power and a second value associated with a power headroom (PH), wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. In some examples, a wireless device may be configured to receive configuration information associated with a report providing information regarding a first power headroom (PH) associated with the FD mode of operation at the UE and a second PH associated with a half-duplex (HD) mode of operation at the UE, and transmit, to a network device, the report, wherein the report comprises a set of values comprising at least a first value indicating the second PH and a second value indicating whether the first PH is within a threshold power of the second PH. In some examples, a wireless device may be configured to receive configuration information associated with a report indicating at least a first Pₘₐₓ associated with the FD mode of operation at the UE, and transmit, to a network device, the report, wherein the report comprises at least a first value indicating the first Pₘₐₓ, wherein the first Pₘₐₓ is based on at least one measure of self-interference. In some examples, a network device may be configured to transmit, to a UE that supports an FD mode of operation, configuration information associated with a report indicating a first Pₘₐₓ associated with the FD mode of operation at the UE and a second Pₘₐₓ associated with a HD mode of operation at the UE, and receive, from the UE, the report, wherein the report comprises a set of values comprising a first value associated with a maximum uplink power and a second value associated with a PH, wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. In some examples, a network device may be configured to transmit, to a UE that supports an FD mode of operation, configuration information associated with a report providing information regarding a first PH associated with the FD mode of operation at the UE and a second PH associated with a HD mode of operation at the UE, and receive, from the UE, the report, wherein the report comprises a set of values comprising at least a first value indicating the second PH and a second value indicating whether the first PH is within a threshold power of the second PH. In some examples, a network device may be configured to transmit, to a UE that supports an FD mode of operation, configuration information associated with a report indicating at least a first Pₘₐₓ associated with the FD mode of operation at the UE, and receive, from the UE, the report, wherein the report comprises at least a first value indicating the first Pₘₐₓ, wherein the first Pₘₐₓ is based on at least one measure of self-interference.

Particular aspects of the subject matter described in this disclosure can be implemented to realize one or more of the following potential advantages. In some examples, by indicating the PH or P_{cmax} for each of the HD mode of operation and the SBFD mode of operation at an SBFD-capable UE, the described techniques can be used to perform power control for the SBFD-capable UE that accounts for interference (e.g., SI or SI and external interference) experienced at the SBFD-capable UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspects. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

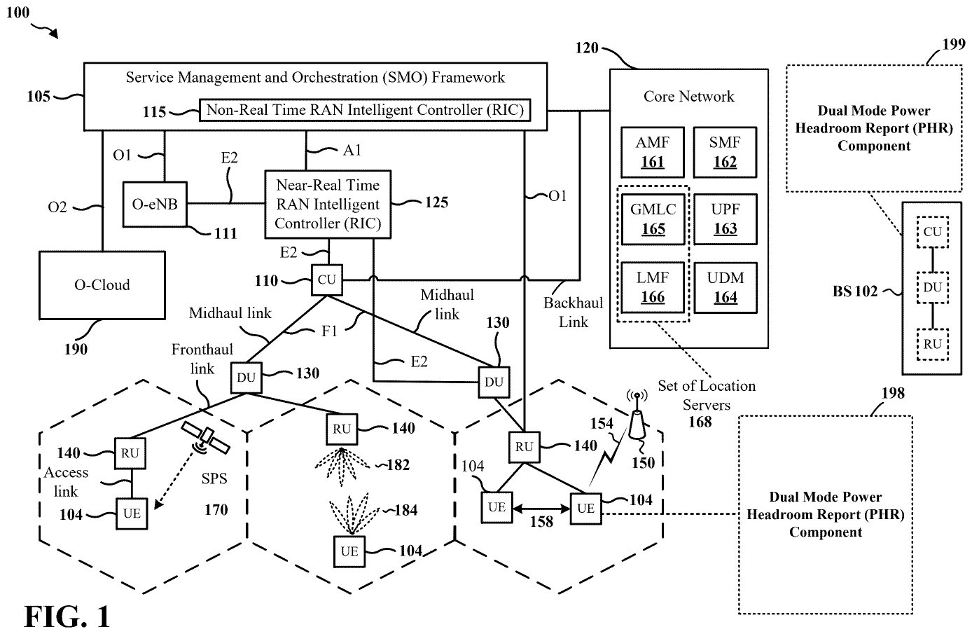

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a dual mode PHR component 198 that may be configured to receive configuration information associated with a report indicating a Pₘₐₓ associated with an FD mode of operation at the UE, and transmit, to a network device, the report, wherein the report comprises a set of values comprising a Pₘₐₓ value associated with the FD mode of operation at the UEan FD. In certain aspects, the base station 102 may have a dual mode PHR component 199 that may be configured to transmit, to a UE that supports an FD mode of operation, configuration information associated with a report indicating a Pₘₐₓ associated with the FD mode of operation at the UE, and receive, from the UE, the report, wherein the report comprises a set of values comprising a Pₘₐₓ value associated with the FD mode of operation at the UEan FD. In some aspects, the dual mode PHR component 198 may be configured to receive configuration information associated with a report indicating a first Pₘₐₓ associated with the FD mode of operation at the UE and a second Pₘₐₓ associated with a HD mode of operation at the UE, and transmit, to a network device, the report, wherein the report comprises a set of values comprising a first value associated with a maximum uplink power and a second value associated with a PH, wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. The dual mode PHR component 198, in some aspects, may be configured to receive configuration information associated with a report providing information regarding a first PH associated with the FD mode of operation at the UE and a second PH associated with a HD mode of operation at the UE, and transmit, to a network device, the report, wherein the report comprises a set of values comprising at least a first value indicating the second PH and a second value indicating whether the first PH is within a threshold power of the second PH. In some aspects, the dual mode PHR component 198 may be configured to receive configuration information associated with a report indicating at least a first Pₘₐₓ associated with the FD mode of operation at the UE, and transmit, to a network device, the report, wherein the report comprises at least a first value indicating the first Pₘₐₓ, wherein the first Pₘₐₓ is based on at least one measure of self-interference. In some aspects, the dual mode PHR component 199 may be configured to transmit, to a UE that supports an FD mode of operation, configuration information associated with a report indicating a first Pₘₐₓ associated with the FD mode of operation at the UE and a second Pₘₐₓ associated with a HD mode of operation at the UE, and receive, from the UE, the report, wherein the report comprises a set of values comprising a first value associated with a maximum uplink power and a second value associated with a PH, wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. The dual mode PHR component 199, in some aspects, may be configured to transmit, to a UE that supports an FD mode of operation, configuration information associated with a report providing information regarding a first PH associated with the FD mode of operation at the UE and a second PH associated with a HD mode of operation at the UE, and receive, from the UE, the report, wherein the report comprises a set of values comprising at least a first value indicating the second PH and a second value indicating whether the first PH is within a threshold power of the second PH. In some aspects, the dual mode PHR component 199 may be configured to transmit, to a UE that supports an FD mode of operation, configuration information associated with a report indicating at least a first Pₘₐₓ associated with the FD mode of operation at the UE, and receive, from the UE, the report, wherein the report comprises at least a first value indicating the first Pₘₐₓ, wherein the first Pₘₐₓ is based on at least one measure of self-interference. Although the following description may be focused on 5G NR, the concepts described herein may be applicable to other similar areas, such as LTE, LTE-A, CDMA, GSM, and other wireless technologies.

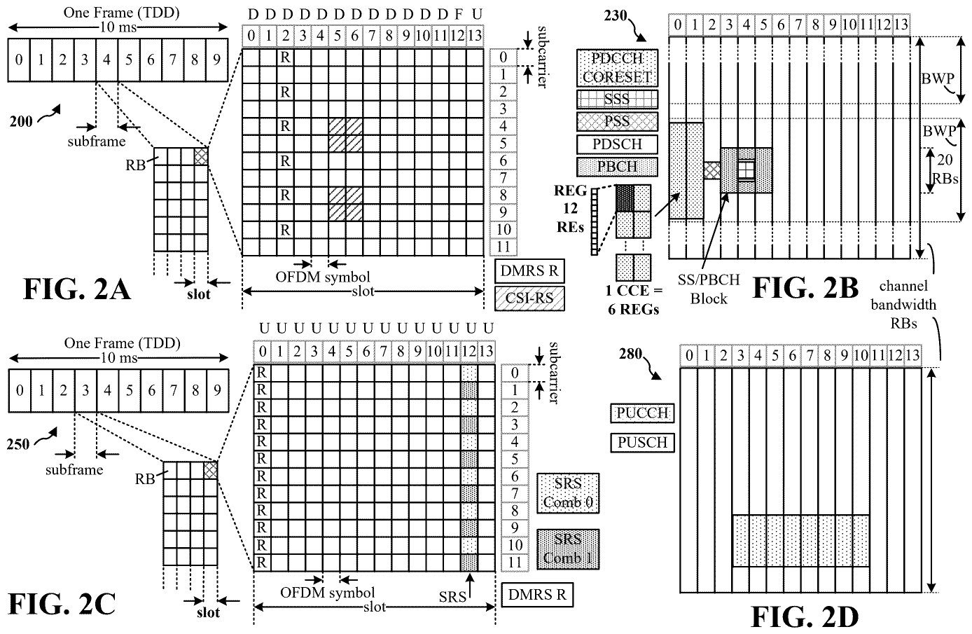

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be time division duplexed (TDD) in which for a particular set of subcarriers (carrier system bandwidth), subframes within the set of subcarriers are dedicated for either DL or UL, or may be frequency division duplexed (FDD) in which for a particular set of subcarriers (carrier system bandwidth), subframes within the set of subcarriers are dedicated for both DL and UL (with different subsets of the particular set of subcarriers associated with either DL or UL). In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

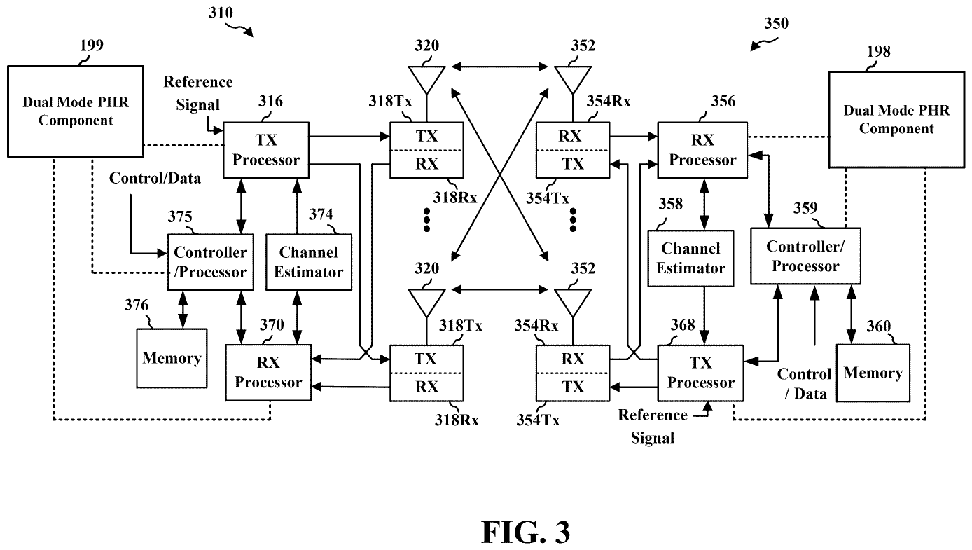

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the dual mode PHR component 198 of FIG. 1.

At least one of the TX processor 316, the RX processor 370, and the controller/processor 375 may be configured to perform aspects in connection with the dual mode PHR component 199 of FIG. 1.

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time, may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. As one example, full duplex operation may enable a base station to transmit a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

There may be various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication.

In some aspects, a first base station may transmit and receive full duplex communication with a first UE and a second UE that transmit or receive half-duplex communication in a half-duplex mode. In some aspects, a base station may transmit and receive full-duplex communication with a UE that operates in a full-duplex mode.

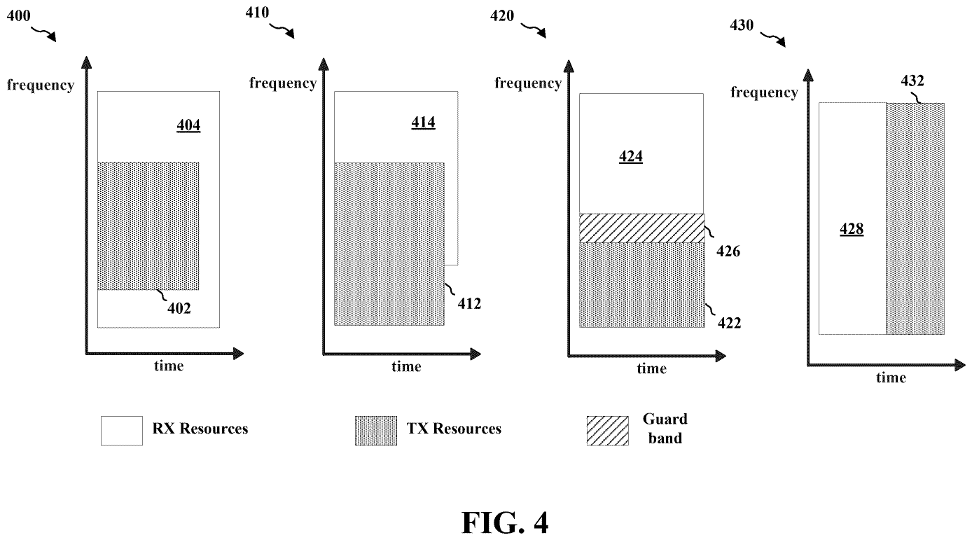

Full duplex communication may be in the same frequency band. The uplink and downlink communication may be in different frequency sub-bands, in the same frequency sub-band, or in partially overlapping frequency sub-bands. FIG. 4 illustrates a first example 400 and a second example 410 of in-band full-duplex (IBFD) resources and a third example 420 of SBFD resources. In IBFD, signals may be transmitted and received in overlapping times and overlapping in frequency. As shown in the first example 400, a time and a frequency allocation of transmission resources 402 may fully overlap with a time and a frequency allocation of reception resources 404. In the second example 410, a time and a frequency allocation of transmission resources 412 may partially overlap with a time and a frequency of allocation of reception resources 414.

IBFD contrasts with sub-band FDD, where transmission and reception resources may overlap in time using different frequencies, as shown in the third example 420. In the third example 420, the UL, the transmission resources 422 are separated from the reception resources 424 by a guard band 426. The guard band may be frequency resources, or a gap in frequency resources, provided between the transmission resources 422 and the reception resources 424. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex.”

A fourth example 430 illustrates an example of half-duplex (HD) resources, which may be referred to as non-SBFD (or TDD) resources, in which the reception resources 428 do not overlap in time with the transmission resources 432. In some aspects, a cell may schedule a first set of slots for non-SBFD (e.g., TDD) resources and a second set of slots for SBFD resources that may be used by a UE in one of the HD mode of operation or in the FD mode of operation (or, more specifically, the SBFD mode of operation).

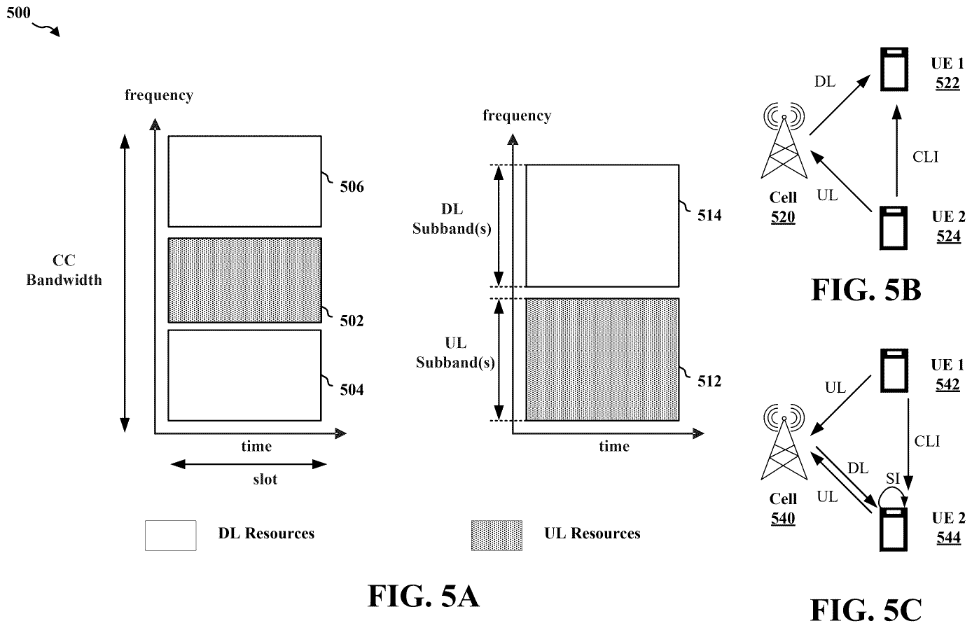

FIG. 5A is a diagram 500 illustrating an example of a resource allocation for a SBFD operation. FIG. 5B is a diagram illustrating two UEs (e.g., UE 1 522 and UE 2 524) operating in a half-duplex mode of operation. As shown in FIG. 5B, a cell 520 may have DL communication with one UE (e.g., UE 1 522), and simultaneously have UL communication with another UE (e.g., UE 2 524) on the same slot. The UL communication from one UE (e.g., UE 2 524), in some aspects, may cause cross-link interference (CLI). In one example, the DL communication with UE 1 522 may utilize DL resources 504, 506, and the UL communication with UE 2 524 may utilize UL resources 502. In another example, the DL communication with UE 1 522 may utilize DL resources 514, and the UL communication with UE 2 524 may utilize UL resources 512.

FIG. 5C is a diagram illustrating a first UE (e.g., UE 1 542) operating in a half-duplex mode of operation and a second UE (e.g., UE 2 544) operating in a full-duplex, or SBFD, mode of operation. As shown in FIG. 5C, a cell 540 may have UL and DL communication with one UE (e.g., UE 2 544) on the same slot. The UL communication from the UE (e.g., UE 2 544), in some aspects, may cause self-interference (SI) for the DL communication from the cell 540 to the UE (e.g., UE 2 544). In one example, the DL communication with UE 2 544 may utilize DL resources 504, 506, and the UL communication with UE 2 544 may utilize UL resources 502. In another example, the DL communication with UE 2 544 may utilize DL resources 514, and the UL communication with UE 2 544 may utilize UL resources 512. In another example, the cell 540 may have DL communication with one UE (e.g., UE 2 544), and simultaneously have UL communication with another UE (e.g., UE 1 542) on the same slot. The UL communication from one UE (e.g., UE 1 542), in some aspects, may cause cross-link interference (CLI) for the other UE (e.g., UE 2 544). In one example, the DL communication with UE 2 544 may utilize DL resources 504, 506, and the UL communication with UE 1 542 may utilize UL resources 502. In another example, the DL communication with UE 2 544 may utilize DL resources 514, and the UL communication with UE 1 542 may utilize UL resources 512.

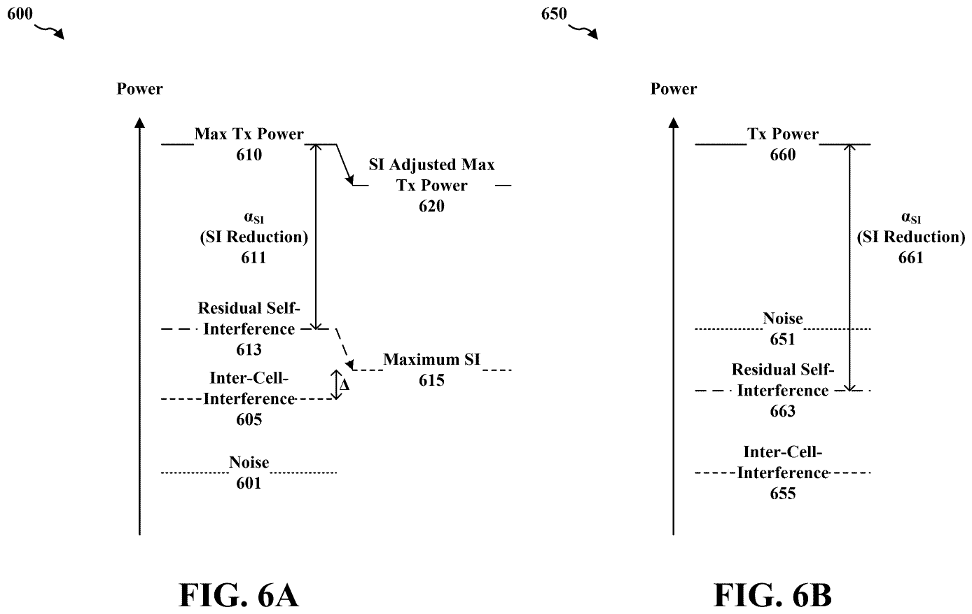

As discussed above, a UE, in some aspects, may report a maximum transmit power (a P_{cmax,f,c} for a carrier frequency f and a cell c, which may be referred to as a P_{cmax} where the dependency on the carrier frequency and the cell is not specifically relevant to the discussion) and a PH indicating a difference between the reported maximum transmit power and a current transmission power. A first P_{cmax} associated with the HD mode of operation may not depend on interference at the UE, while a second P_{cmax} associated with the SBFD mode of operation may depend on interference at the UE. FIG. 6A is a diagram 600 illustrating a first example of a maximum transmit power calculated based on interference. Diagram 600 illustrates that a UE (e.g., a SBFD-capable UE) may be associated with a maximum transmit power 610 that does not depend on the interference (e.g., maximum transmit power 610 may correspond to a first P_{cmax} associated with the HD mode of operation). For a transmission at the maximum transmit power 610, the UE may be able to mitigate the self-interference (e.g., based on a factor αₛₗ 611) such that a residual SI 613 is experienced at the UE. Diagram 600 illustrates that the other sources of interference/distortion may include inter-cell interference 605 (as a non-limiting example of external interference) and noise 601. The sum of the interferences/distortions may be referred to as interference over thermal (IoT). The residual SI 613, in some aspects, may be limited to being no greater than the noise plus external interference plus an offset, e.g., may not be allowed to reduce a link budget by more than the offset (e.g., A). Accordingly, the maximum transmit power 610 (e.g., the first P_{cmax} associated with the HD mode of operation) may not be used for the SBFD mode of operation and a SI-adjusted maximum transmit power 620 (e.g., a second P_{cmax} associated with the SBFD mode of operation) may be calculated to reduce the residual interference to be no greater than the maximum residual SI 615.

FIG. 6B is a diagram 650 illustrating a second example of a maximum transmit power calculated based on interference. Diagram 650 illustrates that a UE (e.g., a SBFD-capable UE) may be associated with a maximum transmit power 660 that does not depend on the interference (e.g., maximum transmit power 660 may correspond to a first P_{cmax} associated with the HD mode of operation). For a transmission at the maximum transmit power 660, the UE may be able to mitigate the self-interference (e.g., based on a factor αₛₗ 661) such that a residual SI 663 is experienced at the UE. Diagram 650 illustrates that the other sources of interference/distortion may include inter-cell interference 655 (as a non-limiting example of external interference) and noise 651. As described in relation to FIG. 6A, the residual SI 663, in some aspects, may be limited to being no greater than the noise plus external interference plus an offset, e.g., may not be allowed to reduce a link budget by more than the offset (e.g., 4). As the maximum transmit power 660 (e.g., the first P_{cmax} associated with the HD mode of operation) is associated with a residual SI 663 that is lower (e.g., less powerful) than the noise 651, the maximum transmit power 660 may be indicated as a second P_{cmax} associated with the SBFD mode of operation.

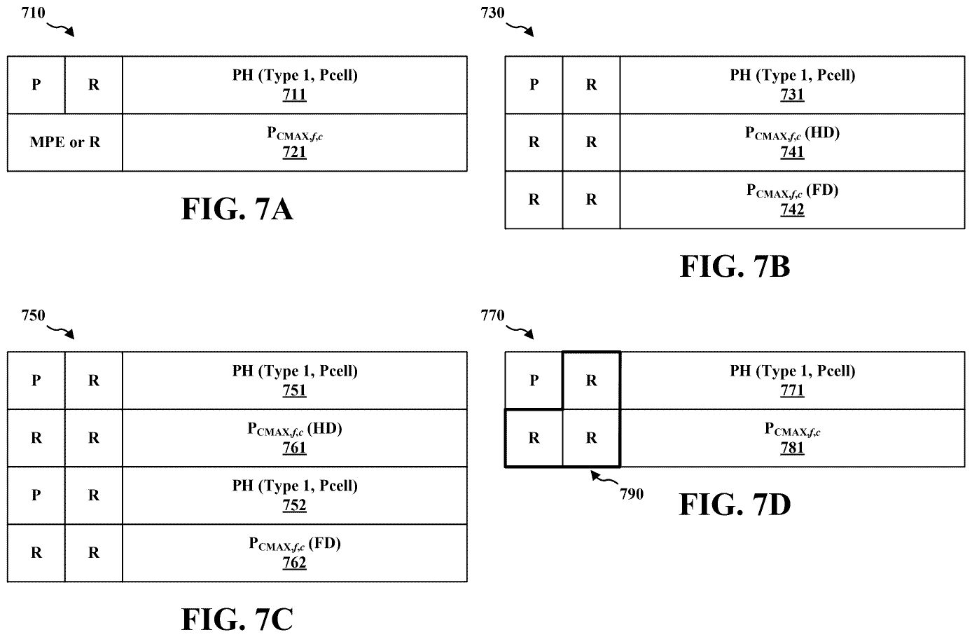

In some aspects, the P_{cmax,f,c} and the PH may be included in a PHR. FIG. 7A illustrates an example PHR MAC-CE 710 for reporting a single P_{cmax} and a PH. The PHR report may be a MAC-CE and may include a PH 711 and a P_{cmax} 721 for a single serving cell (e.g., the PHR may be a single entry PHR MAC-CE). The PH and P_{cmax} may, in some aspects, be specified as a value from 0 to 63 in a set (or field) including 6 bits, where the different values are mapped to known values for the PH and P_{cmax} in a set of tables. The “P” field may be used to indicate additional information, where the additional information may depend on a frequency range of an associated transmission. A PHR may be one of a plurality of types. For example, a first type, or Type 1, PH or PHR may be associated with a physical uplink shared channel (PUSCH) (e.g., a PUSCH-only transmission on the carrier), a second type, or Type 2, PH or PHR may be associated with a PUSCH and a physical uplink control channel (PUCCH), and third type, or Type 3, PH or PHR may be associated with a sounding reference signal (SRS) not associated with a PUSCH. The PHR may be based on an actual transmission (e.g., a PUSCH, a PUSCH and PUCCH, or SRS transmission) or a reference transmission and/or format based on higher layer (e.g., radio resource control (RRC)) signaling of one of a configured grant and/or periodic/semi-persistent PDCCH monitoring occasion. In some aspects, the method of calculating the PH may depend on the type of PH and/or PHR being reported and whether the PH is based on an actual transmission or a reference transmission. The PHR may further depend on higher layer signaling of configured grant, and/or periodic/semi-persistent, sounding reference signal transmissions and downlink control information (DCI) received by a reporting UE in a given period which may be based on whether the PHR will be reported in PUSCH scheduled by a DCI or a CG-PUSCH.

The higher layer signaling may indicate a plurality of parameters for a PHR transmitted, for example, in a medium access control (MAC) control element (CE) (MAC-CE). The parameters may include a first timer for triggering a PHR report (e.g., phr-PeriodicTimer), where the first timer controls the periodicity of PHR reporting such that when the first timer expires, a PHR is triggered, a second timer for preventing subsequent PHR reporting (e.g., a phr-ProhibitTimer) that prevents the UE from reporting PHR too frequently such that before the expiration of the second timer PHR reporting may be prohibited. Other parameters include a first format parameter indicating whether to use a Multiple Entry PHR MAC CE or a Single Entry PHR MAC CE, and a second format parameter indicating if power headroom should be reported as two PHRs, each associated with an SRS (Sounding Reference Signal) resource set.

Various aspects relate generally to extending a PHR or P_{cmax} reporting for a UE (e.g., a SBFD-capable UE) that supports operation in different HD modes of operation (e.g., associated with TDD or SBFD slots and/or symbols) or an FD mode of operation (e.g., associated with SBFD slots and/or symbols). Some aspects more specifically relate to new formats and/or configurations for signaling associated with PHR or P_{cmax} reporting including an indication of a PH or P_{cmax} for each of a HD mode of operation and a SBFD mode of operation at the UE. In some examples, a wireless device may be configured to receive configuration information associated with a report indicating a Pₘₐₓ associated with an FD mode of operation at the UE, and transmit, to a network device, the report, wherein the report comprises a set of values comprising a Pₘₐₓ value associated with the FD mode of operation at the UE. In some examples, a network device may be configured to transmit, to a UE that supports an FD mode of operation, configuration information associated with a report indicating a Pₘₐₓ associated with the FD mode of operation at the UE, and receive, from the UE, the report, wherein the report comprises a set of values comprising a Pₘₐₓ value associated with the FD mode of operation at the UE. In some examples, a wireless device may be configured to receive configuration information associated with a report indicating a first Pₘₐₓ associated with the FD mode of operation at the UE and a second Pₘₐₓ associated with a HD mode of operation at the UE, and transmit, to a network device, the report, wherein the report comprises a set of values comprising a first value associated with a maximum uplink power and a second value associated with a power headroom (PH), wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. In some examples, a wireless device may be configured to receive configuration information associated with a report providing information regarding a first power headroom (PH) associated with the FD mode of operation at the UE and a second PH associated with a half-duplex (HD) mode of operation at the UE, and transmit, to a network device, the report, wherein the report comprises a set of values comprising at least a first value indicating the second PH and a second value indicating whether the first PH is within a threshold power of the second PH. In some examples, a wireless device may be configured to receive configuration information associated with a report indicating at least a first Pₘₐₓ associated with the FD mode of operation at the UE, and transmit, to a network device, the report, wherein the report comprises at least a first value indicating the first Pₘₐₓ, wherein the first Pₘₐₓ is based on at least one measure of self-interference. In some examples, a network device may be configured to transmit, to a UE that supports an FD mode of operation, configuration information associated with a report indicating a first Pₘₐₓ associated with the FD mode of operation at the UE and a second Pₘₐₓ associated with a HD mode of operation at the UE, and receive, from the UE, the report, wherein the report comprises a set of values comprising a first value associated with a maximum uplink power and a second value associated with a PH, wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. In some examples, a network device may be configured to transmit, to a UE that supports an FD mode of operation, configuration information associated with a report providing information regarding a first PH associated with the FD mode of operation at the UE and a second PH associated with a HD mode of operation at the UE, and receive, from the UE, the report, wherein the report comprises a set of values comprising at least a first value indicating the second PH and a second value indicating whether the first PH is within a threshold power of the second PH. In some examples, a network device may be configured to transmit, to a UE that supports an FD mode of operation, configuration information associated with a report indicating at least a first Pₘₐₓ associated with the FD mode of operation at the UE, and receive, from the UE, the report, wherein the report comprises at least a first value indicating the first Pₘₐₓ, wherein the first Pₘₐₓ is based on at least one measure of self-interference.

As described above, a PHR reporting from a UE may be based on known (preconfigured) or configured parameters and/or formats. In some aspects, for PHR Type 1 (or PHR Type 3) in SBFD symbols based on actual/reference transmission of PUSCH (or SRS), a UE may compute a first PHR (or one or more of a PH and Pₘₐₓ) based on a current UE duplex mode of operation (e.g., one of a HD mode of operation or FD mode of operation) and may additionally compute a second PHR (or one or more of a PH and Pₘₐₓ) of an assumed (reference, hypothetical, or virtual) transmission associated with the other duplex mode. In some aspects, the computation and/or the calculation of the first PHR and the second PHR may be based on a same RB allocation, rank, modulation order, RB locations, etc. of the actual/reference transmission. The maximum power reduction terms (e.g., MPR, A-MPR, and P-MPR) used in the computation and/or the calculation of the first PHR, in some aspects, may be used in the computation and/or the calculation of the second PHR.

Based on the computed first PHR and, in some aspects, the second PHR, the UE may generate a PHR (a PHR MAC-CE). The generated PHR, in some aspects, may include a PH value and a Pₘₐₓ value (e.g., a configured maximum Tx Power), associated with a first SBFD mode of operation (e.g., one of an HD, or an FD, mode operation) and may further include, for the other (hypothetical/virtual) SBFD mode of operation (e.g., one of an FD, or an HD, mode operation, respectively), either (1) an additional Pₘₐₓ value or (2) an additional PH value and an additional Pₘₐₓ value.

FIG. 7B is a diagram illustrating an example PHR MAC-CE 730 (e.g., an example PHR MAC-CE structure/format) used to transmit PHR information for a dual-mode PHR reporting including an additional Pₘₐₓ value. FIG. 7B illustrates that a first PH field 731 may be used to report a PH value for a first (e.g., a current, actual, or active) mode of SBFD operation (e.g., FIG. 7B illustrates the case of the first mode of SBFD operation being a HD mode of operation). The PHR MAC-CE 730, in some aspects, may further include at least a first Pₘₐₓ value in a first max power field 741 and a second Pₘₐₓ value in a second max power field 742. In some aspects the second Pₘₐₓ value may be specified as a delta (or difference) from the first Pₘₐₓ value and may, in some aspects, be able to use fewer bits to indicate the second Pₘₐₓ value as the difference is likely to be in a smaller range than the range of reportable Pₘₐₓ values. The first Pₘₐₓ value in the first max power field 741 may be associated with the first (e.g., a current, actual, or active) mode of SBFD operation (assuming, for FIG. 7B, that the first mode of operation is an HD mode of operation) and the second Pₘₐₓ value in the second max power field 742 may be associated with a second (e.g., alternate, hypothetical, virtual, or inactive) mode of SBFD operation (e.g., in the example of FIG. 7B, the FD mode of operation). In some aspects, the use of the PHR MAC-CE 730 may be based on a related slot being configured for SBFD (e.g., configured to use a SBFD format). In a first implementation, the first mode of SBFD operation associated with the first PH value and the first Pₘₐₓ value may be assumed, configured, and/or defined to be the HD mode of operation (where in a second, alternate implementation the first PH field 731 and the first max power field 741 in some aspects may be assumed, configured, and/or defined to be the FD mode of operation to achieve a similar effect). The second Pₘₐₓ value in the second max power field 742, in the first implementation, may be assumed, configured, and/or defined to be the FD mode of operation (where the second max power field 742 in the second, alternate implementation may be assumed, configured, and/or defined to be the HD mode of operation to achieve a similar effect). In some aspects, the first PH field 731 and the corresponding PH value may be used in association with each of the SBFD modes of operation (e.g., the HD, and FD, modes of operation) to calculate the PH available in each mode of operation. In a third implementation, the first PH field 731 and the first max power field 741 (and corresponding PH value and first Pₘₐₓ) may be associated with a current (e.g., actual or active) mode of SBFD operation while the second max power field 742 is associated with the alternate (e.g., hypothetical, virtual, or inactive) mode of SBFD operation. The current mode of operation (e.g., in either the first, second, or third implementations), may be indicated in one of the reserved bits (indicated as “R” in FIG. 7B) available in the PHR MAC-CE 730.

FIG. 7C is a diagram illustrating an example PHR MAC-CE 750 (e.g., an example PHR MAC-CE structure/format) used to transmit PHR information for a dual-mode PHR reporting including an additional PH value and an additional Pₘₐₓ value. FIG. 7C illustrates that the first PH field 751 may be used to report a PH value for a first (e.g., a current, actual, or active) mode of SBFD operation (e.g., FIG. 7C illustrates the case of the first mode of SBFD operation being a HD mode of operation) and a second PH value in second PH field 752 may be used to report a PH value for a second (e.g., alternate, hypothetical, virtual, or inactive) mode of SBFD operation (e.g., FIG. 7C illustrates the case of the second mode of SBFD operation being an FD mode of operation). The PHR MAC-CE 750, in some aspects, may further include at least a first Pₘₐₓ value in a first max power field 761 and a second Pₘₐₓ value in a second max power field 762. The first Pₘₐₓ value in the first max power field 761 may be associated with the first (e.g., a current, actual, or active) mode of SBFD operation (assuming, for FIG. 7C, that the first mode of operation is an HD mode of operation) and the second Pₘₐₓ value in the second max power field 762 may be associated with the second (e.g., alternate, hypothetical, virtual, or inactive) mode of SBFD operation (e.g., in the example of FIG. 7C, the FD mode of operation). In some aspects, the use of the PHR MAC-CE 750 may be based on a related slot being configured for SBFD (e.g., configured to use a SBFD format). In a first implementation, the first mode of SBFD operation associated with the first PH value and the first Pₘₐₓ value may be assumed, configured, and/or defined to be the HD mode of operation (where in a second, alternate implementation the first PH field 751 and the first max power field 761 in some aspects may be assumed, configured, and/or defined to be the FD mode of operation to achieve a similar effect). The second Pₘₐₓ value in the second max power field 762, in the first implementation, may be assumed, configured, and/or defined to be the FD mode of operation (where the second max power field 762 in the second, alternate implementation may be assumed, configured, and/or defined to be the HD mode of operation to achieve a similar effect). In some aspects, the first PH field 751 and the corresponding PH value may be used in association with each of the SBFD modes of operation (e.g., the HD, and FD, modes of operation) to calculate the PH available in each mode of operation. In a third implementation, the first PH field 751 and the first max power field 761 (and corresponding PH value and first Pₘₐₓ value) may be associated with a current (e.g., actual or active) mode of SBFD operation while the second max power field 762 is associated with the alternate (e.g., hypothetical, virtual, or inactive) mode of SBFD operation. The current mode of operation (e.g., in either the first, second, or third implementations), may be indicated in one of the reserved bits (indicated as “R” in FIG. 7C) available in the PHR MAC-CE 750. In some aspects, the use of either the PHR MAC-CE 730 or the PHR MAC-CE 750 may be indicated in one of the reserved bits (an additional reserved bit if already using a reserved bit to indicate a current, or first, mode of SBFD operation). For example, in some aspects, a UE providing the PHR may indicate a current mode of the SBFD operation (e.g., using a first reserved bit) such that providing the PH value and/or the Pₘₐₓ value for the second (e.g., alternate, hypothetical, virtual, or inactive) mode of SBFD operation may be optional and the (additional) reserved bit indicating the use of the PHR MAC-CE 730 or the PHR MAC-CE 750 may indicate the inclusion of the additional field(s) associated with the second (e.g., alternate, hypothetical, virtual, or inactive) mode of SBFD operation.

In some aspects, if the PHR is associated with a reference (as opposed to an actual) transmission, the UE may compute a PHR (a first PH value) for the HD mode of operation and use the PHR MAC-CE 730 to report the first PH value in the first PH field 731, a first Pₘₐₓ value in a first max power field 741, and a second Pₘₐₓ value in a second max power field 742. The UE may use one of the reserved bits to indicate that the first PH value and the first Pₘₐₓ value are associated with the HD mode of operation (e.g., identifying the HD mode of operation as a “current” mode of operation). Based on the association with a reference transmission and the indication of the current SBFD mode of operation being the HD mode of operation, a receiving network device may expect the second Pₘₐₓ value in the second max power field 742 and may interpret the second Pₘₐₓ value as being associated with the FD mode of operation (for the SBFD slot).

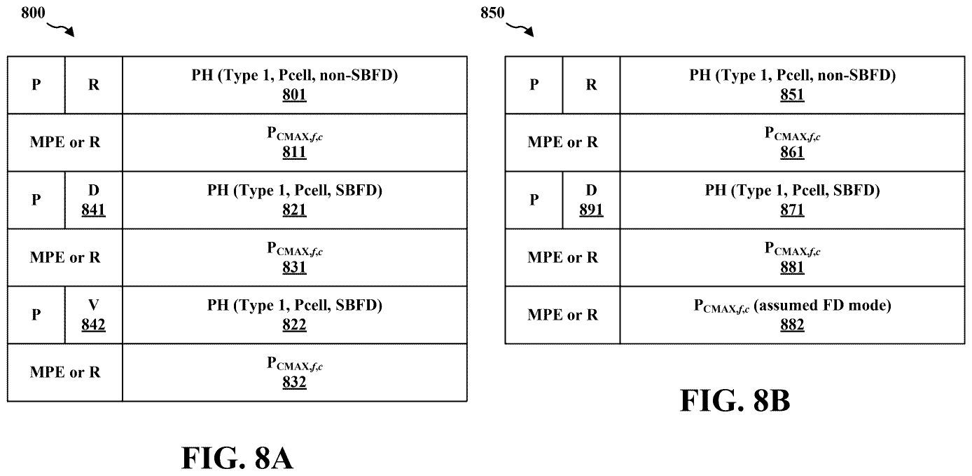

In some aspects, for PHR Type 1 (or PHR Type 3) in SBFD symbols based on an actual transmission of PUSCH (or SRS), a UE may compute a first PHR (or one or more of a first PH and first Pₘₐₓ) based on a current UE duplex mode of operation (e.g., one of a HD mode of operation or FD mode of operation). FIG. 7D is a diagram illustrating an example PHR MAC-CE 770 (e.g., an example PHR MAC-CE structure/format) used to transmit PHR information for a current mode of SBFD operation. FIG. 7D illustrates that a first PH field 771 may be used to report a PH value for a current (e.g., or active) mode of SBFD operation. The PHR MAC-CE 770, in some aspects, may further include a first Pₘₐₓ value in a first max power field 781. The first Pₘₐₓ value in the first max power field 781 may be associated with the current (e.g., or active) mode of SBFD operation. In some aspects, the use of the PHR MAC-CE 770 may be based on a related slot being configured for SBFD (e.g., configured to use a SBFD format). The current mode of operation, in some aspects, may be indicated in a reserved bit in the set of reserved bits 790 available in the PHR MAC-CE 770 (e.g., in one of the reserved bits indicated as “R” in FIG. 7D such as the reserved bit corresponding to the first PH field 771 in the first octet as described below in relation to the reserved bit 841 of FIG. 8A, or the reserved bit 891 of FIG. 8B, described below). In some aspects, the UE may be RRC configured to use one of PHR MAC-CE 730, PHR MAC-CE 750, or PHR MAC-CE 770. For example, a parameter (e.g., a ‘twoPHR-duplex’ parameter) included in RRC signaling and/or in RRC configuration may indicate whether to use PHR MAC-CE 750 (e.g., a PHR format/structure having two PH values) or at least one of PHR MAC-CE 730 or PHR MAC-CE 770 (e.g., a PHR format/structure having one PH values).

In some aspects, the parameter (e.g., the ‘twoPHR-duplex’ parameter) indicating whether to report one or two PH values may be used in addition to another parameter (e.g., a ‘twoPHRmode’ parameter) included in RRC signaling and/or in RRC configuration to indicate whether to report a PH value for a single mode of operation or to report PH values for two modes of operation (e.g., whether to report a PH value for either (1) one of a TDD mode of operation or a SBFD mode of operation or (2) both of the TDD and SBFD modes of operation). If the ‘twoPHRmode’ parameter indicates for the UE to report a single-mode PH value in a PHR (e.g., to use single-mode PH value PHR reporting), the ‘twoPHR-duplex’ parameter may indicate for the UE to report one or two PH values for the SBFD mode of operation (e.g., a PH value for one, or each of, the HD and FD modes of SBFD operation). In some aspects, the single-mode PH value PHR reporting may use PHR MAC-CE 710 of FIG. 7A, PHR MAC-CE 730 of FIG. 7B, or PHR MAC-CE 770 of FIG. 7D if the ‘twoPHR-duplex’ parameter indicates for the UE to report one PH value for the SBFD mode of operation or may use PHR MAC-CE 750 of FIG. 7C if the ‘twoPHR-duplex’ parameter indicates for the UE to report two PH values for the SBFD modes of operation.

FIG. 8A is a diagram illustrating an example PHR MAC-CE 800 (e.g., an example PHR MAC-CE structure/format) used to transmit PHR information for a TDD mode of operation, an HD mode of SBFD operation, and an FD mode of SBFD operation. FIG. 8A illustrates that a first PH field 801 may be used to report a first PH value and a first max power field 811 may be used to report a first Pₘₐₓ value for a non-SBFD (e.g., TDD) mode of operation. FIG. 8A further illustrates that the PHR MAC-CE 800 may include additional fields corresponding to the fields of FIG. 7C (e.g., a second PH field 821 corresponding to the first PH field 751; a third PH field 822 corresponding to the second PH field 752; a second max power field 831 corresponding to the first max power field 761; and a third max power field 832 corresponding to the second max power field 762). FIG. 8A illustrates a reserved bit 841 (e.g., a “D” bit) that may be used (purposed and/or repurposed) to indicate a duplex mode associated with the PH value reported in the second PH field 821 and a reserved bit 842 (e.g., a “V” bit) that may be used (purposed and/or repurposed) to indicate that a duplex mode associated with the PH value reported in the third PH field 822 (or in the second PH field 821) is associated with a hypothetical and/or virtual transmission.

FIG. 8B is a diagram illustrating an example PHR MAC-CE 850 (e.g., an example PHR MAC-CE structure/format) used to transmit PHR information for a TDD mode of operation, an HD mode of SBFD operation, and an FD mode of SBFD operation. FIG. 8B illustrates that a first PH field 851 may be used to report a first PH value and a first max power field 861 may be used to report a first Pₘₐₓ value for a non-SBFD (e.g., TDD) mode of operation. FIG. 8B further illustrates that the PHR MAC-CE 850 may include additional fields corresponding to the fields of FIG. 7B (e.g., a second PH field 871 corresponding to the first PH field 731; a second max power field 881 corresponding to the first max power field 741; and a third max power field 882 corresponding to the second max power field 742). FIG. 8B illustrates a reserved bit 891 (e.g., a “D” bit) that may be used (purposed and/or repurposed) to indicate a duplex mode associated with the PH value reported in the second PH field 821. As described in relation to FIGS. 7B and 7D, in some aspects, if the reserved bit 891 indicates an HD mode of SBFD operation, the third max power field 882 may be assumed to be present and include a third Pₘₐₓ value associated with the FD mode of SBFD operation. In some aspects, if the reserved bit 891 indicates an HD mode of SBFD operation, the inclusion of the third max power field 882 may be indicated in an additional reserved bit (in the bits labeled “MPE or R” aligned with the second max power field 881 or third max power field 882). If the reserved bit 891 indicates an FD mode of SBFD operation, the third max power field 882 may be assumed to be omitted (wherein the correspondence between fields of PHR MAC-CE 850 and PHR MAC-CE 730 of FIG. 7B becomes a correspondence between the non-omitted SBFD-related fields of PHR MAC-CE 850 and the fields of PHR MAC-CE 770 of FIG. 7D.

In some aspects, the PHR MAC-CE 730 of FIG. 7B may be used to indicate a first PH value for a non-SBFD (e.g., a TDD) mode of operation. For example, if a slot carrying the PHR MAC-CE 730 is a non-SBFD slot, the first PH value in the first PH field 731 (and the first Pₘₐₓ value in the first max power field 741) may be a PH value (and a Pₘₐₓ value) for actual transmissions in the non-SBFD symbols and the second max power field 742 may be used to provide the second Pₘₐₓ value for the FD mode of SBFD operation. In contrast, in some aspects, the PHR MAC-CE 750 may not be used to indicate a first PH value for a non-SBFD (e.g., a TDD) mode of operation. For example, if a slot carrying the PHR MAC-CE 750 is a non-SBFD slot, the first PH value in the first PH field 751 (and the first Pₘₐₓ value in the first max power field 761) may be a PH value (and a Pₘₐₓ value) for actual transmissions in the non-SBFD symbols and the second PH field 752 may be omitted to produce (or revert to) the PHR MAC-CE 730 (e.g., the PHR MAC-CE 730 as used for a non-SBFD slot as described above).

In some aspects, when twoPHR-duplex is configured (or activated), the PHR MAC-CE formats and/or structures described in relation to FIG. 7B, 7C, or 7D may be reused for (e.g., incorporated into, or combined with) a multiple TRP MAC-CE to report the PH values for two SBFD modes in the PHR. current enhanced single and multiple entry PHR for multiple TRP MAC-CE to report two SBFD modes PHR. For example, the network may configure the UE with one or more RRC parameters that indicate for the UE to use a multiple TRP MAC-CE for multiple duplex mode reporting (e.g., dual SBFD modes and/or TDD/SBFD modes). In some aspects, the UE may use one or more reserved bits to indicate whether the MAC-CE is being used for multiple TRP (mTRP) or multiple duplex mode reporting.

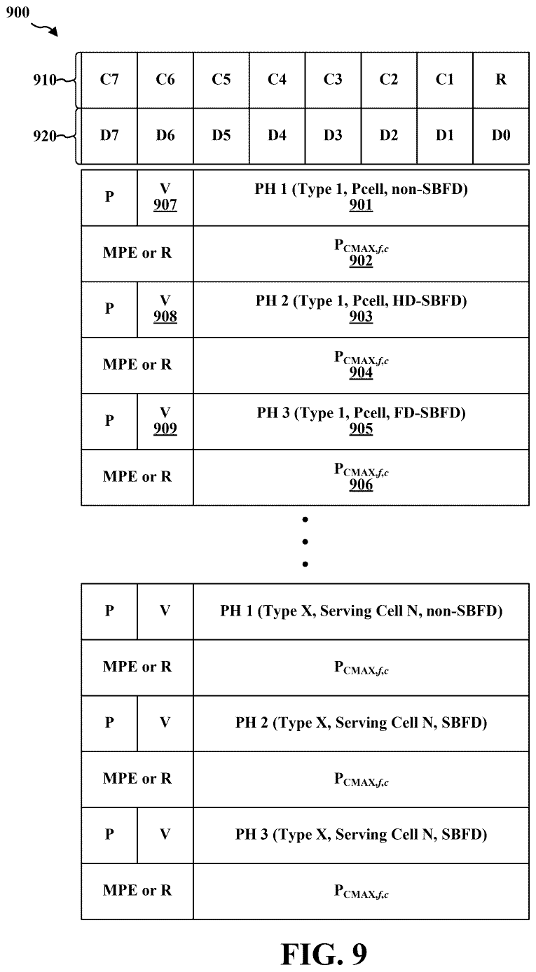

FIG. 9 is a diagram illustrating an example PHR MAC-CE 900 (e.g., an example PHR MAC-CE structure/format) used to transmit PHR information for a TDD mode of operation, an HD mode of SBFD operation, and an FD mode of SBFD operation that may be used for PHR reporting for multiple serving cells and/or TRPs. FIG. 9 illustrates that a first PH field 901 may be used to report a first PH value and a first max power field 902 may be used to report a first Pₘₐₓ value for a non-SBFD (e.g., TDD) mode of operation. FIG. 9 further illustrates that the PHR MAC-CE 900 may include, for each serving cell and/or TRP of the multiple serving cells and/or TRPs, additional fields corresponding to the fields of FIG. 7C (e.g., a second PH field 903 corresponding to the first PH field 751; a third PH field 905 corresponding to the second PH field 752; a second max power field 904 corresponding to the first max power field 761; and a third max power field 906 corresponding to the second max power field 762). FIG. 9 illustrates a bit 907, a bit 908, and a bit 909 (e.g., “V” bits) that may be used (purposed and/or repurposed) to indicate whether an associated PH value (e.g., a PH value included in a same octet of the PHR MAC-CE 900) is based on an actual transmission or a reference (e.g., hypothetical and/or virtual) transmission. Additionally, PHR MAC-CE 900 may include at least two leading octets of bits, a first octet 910 that is a bitmap used to indicate for each of the multiple TRPs (e.g., indexed TRPs associated with a Ct) whether the PHR MAC-CE 900 includes PH and Pₘₐₓ values, and a second corresponding octet 920 that indicates for each Cᵢ (e.g., in a corresponding Dᵢ field) whether the PH and Pₘₐₓ values are provided for a single mode (e.g., one of a TDD, HD, or FD mode of operation) or multiple PH values and multiple Pₘₐₓ values are provided for a corresponding multiple modes of operation (e.g., two or more of TDD, HD, and/or FD modes of operation). While FIG. 9 illustrates that the information for each serving cell or TRP is provided based on the structure of the PHR MAC-CE 800, in other aspects (and depending on the configuration received from the network), the structure for providing the multiple mode PHR information (e.g., multiple PH values and multiple Pₘₐₓ values) may be any of the structures discussed above in relation to FIG. 7B, 7C, 8A, or 8B.

In some aspects, to provide dual SBFD mode reporting without introducing additional overhead associated with providing additional PH values and/or additional Pₘₐₓ values, each PH value (or Pₘₐₓ value) may represent joint values (e.g., a set of values) for both SBFD modes of operation (e.g., a single PH, or Pₘₐₓ, value may be mapped to a pair of PH, or Pₘₐₓ, values) (see Table 2 and Table 3).

TABLE 2
Joint PH values

| PH | HD mode PH | FD mode PH |
|---|---|---|
| 0 | POWER_HEADROOM_0_HD | POWER_HEADROOM_0_FD |
| 1 | POWER_HEADROOM_1_HD | POWER_HEADROOM_1_FD |
| 2 | POWER_HEADROOM_2_HD | POWER_HEADROOM_2_FD |
| 3 | POWER_HEADROOM_3_HD | POWER_HEADROOM_3_FD |
| . . . | . . . | . . . |
| 62 | POWER_HEADROOM_62_HD | POWER_HEADROOM_62_FD |
| 63 | POWER_HEADROOM_63_HD | POWER_HEADROOM_63_FD |

TABLE 3
Joint P_{cmax} values

| PH | HD mode P_{CMAX} | FD mode P_{CMAX} |
|---|---|---|
| 0 | PCMAX_0_HD | PCMAX_0_FD |
| 1 | PCMAX_1_HD | PCMAX_1_FD |
| 2 | PCMAX_2_HD | PCMAX_2_FD |
| 3 | PCMAX_3_HD | PCMAX_3_FD |
| . . . | . . . | . . . |
| 62 | PCMAX_62_HD | PCMAX_62_FD |
| 63 | PCMAX_63_HD | PCMAX_63_FD |

For example, referring to Table 2 and Table 3, the first column may indicate a possible value for a PH value or P_{cmax} value (e.g., the Pₘₐₓ value referred to in the description above), the second column may represent the corresponding PH value or P_{cmax} value for the HD mode of operation, and the third column may represent the corresponding PH value or P_{cmax} value for the FD mode of operation. If the PH value or P_{cmax} value for the HD mode of operation is provided as a value (e.g., an absolute or non-relative value), the corresponding PH value or P_{cmax} value for the FD mode of operation may be provided or indicated as a value (e.g., an absolute or non-relative value) or as a delta (or relative value) from the PH value or P_{cmax} value for the HD mode of operation. In some aspects, the number of bits used to indicate the PH value or P_{cmax} value may be expanded (e.g., by using reserved bits) such that more than 64 entries may be defined for tables corresponding to Table 2 and/or Table 3.

In some aspects, one or more reserved bit(s) may be used to indicate whether a PH value or Pₘₐₓ value associated with one mode is within an offset of x dB of the other mode. In some aspects, a PH value or Pₘₐₓ value may be provided and/or reported for a current SBFD mode and a reserved bit may be used to indicate if a PH value or Pₘₐₓ value of the other SBFD mode of operation is within an offset, or threshold, (e.g., x dB) of the reported and/or provided PH value or Pₘₐₓ value. For example, a UE may report the HD mode PHR and indicate a bit of information in the reserved bits. If the bit is set to a value of 0, it may indicate, in some aspects, that the FD mode PHR is within x dB of the HD mode PHR and if the bit is set to a value of 1, it may indicate that the FD mode PHR is not within x dB of the HD mode PHR. In some aspects, the value “x” associated with the offset, or threshold, may be one of fixed, RRC configured, or indicated by the UE (e.g., in the MAC-CE). In some aspects, if an additional bit (e.g., a bit not indicated as MPE) is available the resolution of the indication may be increased (e.g., four different states may be indicated instead of 2).

In some aspects of PHR reporting, the PHR reporting supports measuring a path loss RS to capture the impact of signal transmission loss. However, for a UE operating in an FD mode of SBFD operation an interference measurement resource may be defined to assist the UE to select and/or determine the Pₘₐₓ value based on current interference conditions. Accordingly, in some aspects, a periodic interference measurement resource may be defined as part of the PHR configuration, and the measurement resource may be configured simultaneously in slots with UL transmissions (in order to measure residual SI). In some aspects, a new interference measurement resource dedicated to enhanced Pₘₐₓ reporting (as discussed in relation to FIGS. 7B, 7C, 7D, 8A, 8B, and 9 may be defined and/or configured. The new interference measurement resource may include non-contiguous measurement resources, e.g., some reserved REs for interference measurement similar to CSI-IM. In some aspects, a UE may reuse existing a L1 CLI-RSSI measurement resource (e.g., a Rel-19 CLI-RSSI resource). For example, the UE may reuse a L1 CLI-RSSI periodic/semi-persistent resource linked to PHR reporting. The UE, in some aspects, may reuse existing a L3 CLI-RSSI measurement resource (e.g., a Rel-16 CLI-RSSI). In some aspects, the L3 CLI-RSSI periodic measurement resource may be linked to PHR reporting.

In some aspects, new signaling may be used to indicate a PH value and/or Pₘₐₓ value for an FD mode of SBFD operation at the UE. For example, a new L2 signaling (UL MAC-CE) may be defined for reporting one or more Pₘₐₓ value(s) (e.g., P_{c,max}) based on one or more interference measurement resources. In some aspects, different interference measurement resources may be used to measure one or more of (1) isolated SI, (2) SI plus CLI, and/or (3) isolated CLI. A triggering mechanism and/or event, in some aspects may be based on (1) a defined timer (e.g., a prohibitTimer) similar to a timer used in association with PHR to avoid overly frequent reporting (e.g., reporting too frequently), (2) a crossing of an SI and/or CLI change threshold, or (3) a crossing of a P_{c,max} change threshold, one or more of which may trigger or control a decision to trigger the new L2 report. In some aspects, the triggering may also occur based on a periodic timer. A new L1 signaling may be used to indicate a PH value and/or P_{c,max} value for an FD mode of SBFD operation at the UE. In some aspects, the new L1 signaling may be an enhancement of the Rel-19 CLI reporting, by defining a new report quantity similar to CLI-RSSI introduced in Rel-19 SBFD. The new L1 signaling, in some aspects, may be based on a CSI-reporting framework.

The UL signal used for measurement of the residual self-interference, in some aspects, may be scheduled by the network (e.g., a serving cell scheduling UL and/or DL for the UE operating in the FD mode of SBFD operation). The network may configure the interference measurement resource to be simultaneous, or significantly overlap in both time and frequency, with a scheduled UL transmission, e.g., a semi-persistent (SP) and/or persistent (P) SRS. In some aspects, some occasions may not be associated with local UL transmissions and may be used for inter-cell interference measurement, i.e., excluding the impact of SI. The measurement resources, in some aspects, may be split measurement resources such as two or more measurement resource occasions, at least one measurement resource occasion for measuring SI (that may also include intercell interference or CLI) and at least one measurement resource for measuring interference without SI. In some aspects, the measurement resources for measuring SI may not be limited to overlapping with scheduled UL transmissions based on the transmission of ‘dummy’ UL transmissions, e.g., CG-PUSCH transmission whether UE has data to transmit or not. In some aspects, the network may not schedule DL reception at the UE at the same time as a SI measurement resource occasion if the UE does not indicate support for simultaneous interference measurement and DL reception. In some aspects, support for simultaneous interference measurement and DL reception may be indicated as a separate UE capability. In some aspects, support for simultaneous interference measurement and DL reception may be assumed based on, or indicated by, an indication of support for the enhanced P_{c,max} reporting (e.g., the new L1 or L2 signaling or the enhanced PHR reporting described above).

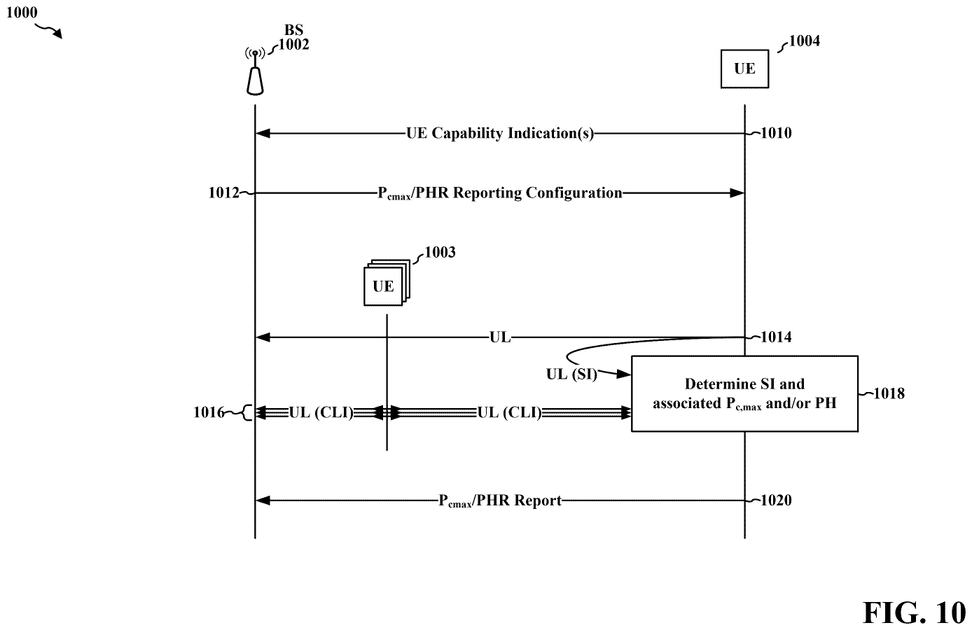

FIG. 10 is a call flow diagram 1000 illustrating a method of wireless communication in accordance with some aspects of the disclosure. The method is illustrated in relation to a base station 1002 (e.g., as an example of a network device or network node that may include one or more components of a disaggregated base station) in communication with a UE 1004 (e.g., as an example of a wireless device). The functions ascribed to the base station 1002, in some aspects, may be performed by one or more components of a network entity, a network node, or a network device (a single network entity/node/device or a disaggregated network entity/node/device as described above in relation to FIG. 1). Similarly, the functions ascribed to the UE 1004, in some aspects, may be performed by one or more components of a wireless device supporting communication with a network entity/node/device. Accordingly, references to “transmitting” in the description below may be understood to refer to a first component of the base station 1002 (or the UE 1004) outputting (or providing) an indication of the content of the transmission to be transmitted by a different component of the base station 1002 (or the UE 1004). Similarly, references to “receiving” in the description below may be understood to refer to a first component of the base station 1002 (or the UE 1004) receiving a transmitted signal and outputting (or providing) the received signal (or information based on the received signal) to a different component of the base station 1002 (or the UE 1004).

The UE 1004, in some aspects, may transmit, and the base station 1002 may receive, one or more UE capability indications 1010. For example, the one or more UE capability indications 1010 may include a first indication of support for the report indicating a first Pₘₐₓ and a second indication of support for measuring the SI during downlink reception, or a combined indication of support for the report indicating the first Pₘₐₓ and support for measuring the SI during downlink reception. The one or more UE capability indications 1010, in some aspects, may include an additional indication of support for an FD mode of operation (e.g., an FD mode of SBFD operation).

The base station 1002, in some aspects, may transmit, and the UE 1004 may receive, a Pₘₐₓ/PHR reporting configuration 1012. The Pₘₐₓ/PHR reporting configuration 1012, in some aspects, may be associated with a report indicating a first Pₘₐₓ associated with an FD mode of operation at the UE. The report, in some aspects, may be associated with (1) a report indicating a first Pₘₐₓ associated with the FD mode of operation at the UE and a second Pₘₐₓ associated with the HD mode of operation at the UE or (2) a report providing information regarding a first PH (or PH value) associated with the FD mode of operation at the UE and a second PH (or PH value) associated with the HD mode of operation at the UE. In some aspects, the Pₘₐₓ/PHR reporting configuration 1012 may indicate (e.g., via a twoPHRmode parameter) whether the set of (reported) values includes a (fifth) value indicating a PH (or PH value) associated with a TDD mode of operation and a (sixth) value indicating a Pₘₐₓ associated with the TDD mode of operation. In some aspects, the Pₘₐₓ/PHR reporting configuration 1012 may indicate whether the set of values includes a (fourth) value indicating a PH associated with an inactive mode of operation, where the active mode of operation is one of the FD mode of operation or the HD mode of operation. The Pₘₐₓ/PHR reporting configuration 1012, in some aspects, may include an indication of resources for measuring a self-interference (SI) at the UE. The Pₘₐₓ/PHR reporting configuration 1012, in some aspects, may include an indication of resources for measuring a cross-cell interference at the UE. The resources for measuring the SI, in some aspects, may include a first set of measurement resources that overlap in both time and frequency with a first uplink transmission from the UE for measuring the SI and a second set of measurement resources that do not overlap in both time and frequency with any uplink transmission from the UE for measurement of inter-cell interference. In some aspects, the first set of measurement resources and the first uplink transmission overlap with the second set of measurement resources in time and do not overlap with the second set of measurement resources in frequency.

The UE 1004, in some aspects, may transmit, and the base station 1002 may receive, UL transmission 1014. The UL transmission 1014, in some aspects, may be one of a scheduled UL transmission (based on the Pₘₐₓ/PHR reporting configuration 1012), a reference signal transmission, or a dummy UL transmission for the purposes of measuring SI. At 1018, the UE may receive the UL transmission 1014 and measure a SI based on the UL transmission 1014. The UE 1004, at 1018, may also measure CLI based on UL transmission 1016 from one or more additional UEs 1003. Based on the SI and/or CLI measured at 1018, the UE 1004 may, at 1018, determine (e.g., compute or calculate) a Pₘₐₓ and PH (or Pₘₐₓ and PH values) for at least an active SBFD mode of operation, and in some aspects for one or more inactive modes of operation (e.g., a TDD mode of operation and/or an inactive SBFD mode of operation).

Based on the Pₘₐₓ and PH determined at 1018 for at least the active SBFD mode of operation, the UE 1004 may transmit, and the base station 1002 may receive, an indication 1020 of one or more of the Pₘₐₓ and PH determined at 1018. In some aspects, the indication 1020 may be a report including a set of values including a Pₘₐₓ value associated with the FD mode of operation at the UE. The set of values, in some aspects, may include a PH value associated with the FD mode of operation at the UE. In some aspects, the report may include a single-bit indication that the PH value is associated with the FD mode of operation at the UE. The Pₘₐₓ value may be a first Pₘₐₓ value, and the set of values may include a second Pₘₐₓ value associated with the HD mode of operation at the UE and a PH value associated with the HD mode of operation. In some aspects, the report may include a single-bit indication that the PH value is associated with the HD mode of operation at the UE. The set of values, in some aspects, may further include an additional indication that the first Pₘₐₓ value is included in the set of values. In some aspects, the set of values may be associated with a slot configured for SBFD operation and the set of values may include an indication of an active mode of operation at the UE. The Pₘₐₓ value, in some aspects, may be a first Pₘₐₓ value, and the configuration 1012 further indicates whether the set of values includes a single PH value associated with one of a HD mode of operation at the UE or the FD mode of operation at the UE or the set of values includes a first PH value associated with the HD mode of operation, a second Pₘₐₓ value associated with the HD mode of operation at the UE, and a second PH value associated with the FD mode of operation. In some aspects, the configuration information further indicates whether the set of values includes a third PH value associated with a time division duplex (TDD) mode of operation and a third Pₘₐₓ value associated with the TDD mode of operation. The Pₘₐₓ value, in some aspects, may be a first Pₘₐₓ value, and the set of values may be a first set of values associated with a first cell and the report may include an additional set of values associated with a corresponding additional cell, and the additional set of values may include at least a second Pₘₐₓ value associated with the FD mode of operation at the UE. In some aspects, the set of values may include a PH value, at least one of the Pₘₐₓ value or the PH value may be a joint indication associated with both the FD mode of operation and a HD mode of operation at the UE. One of the Pₘₐₓ value or the PH value, in some aspects may include a single-mode indication associated with one of the FD mode of operation or the HD mode of operation at the UE, and the joint indication and the single-mode indication together indicate a first Pₘₐₓ value associated with the FD mode of operation at the UE, a second Pₘₐₓ value associated with the HD mode of operation at the UE, a first PH value associated with the FD mode of operation at the UE, and a second PH value associated with the HD mode of operation at the UE. In some aspects, the Pₘₐₓ value may be a first Pₘₐₓ value, and the set of values may include a first PH value associated with a HD mode of operation at the UE and a second Pₘₐₓ value associated with the HD mode of operation at the UE, and the set of values may include an additional value indicating whether a second PH associated with the FD mode of operation at the UE is within a threshold power of the first PH. The report, in some aspects, may be associated with one of a layer 2 (L2) signaling for reporting at least the Pₘₐₓ value associated with the FD mode of operation based on the SI measured at the UE or a layer 1 (L1) signaling for reporting at least the Pₘₐₓ value associated with the FD mode of operation based on the SI measured at the UE. In some aspects, the Pₘₐₓ may be based on a maximum power reduction for meeting a threshold power associated with the FD mode of operation.

In some aspects, the indication 1020 may include a set of values including a first value indicating the first Pₘₐₓ and a second value indicating a second Pₘₐₓ associated with the HD mode of operation at the UE. The first Pₘₐₓ, in some aspects, may be based on a maximum power reduction for meeting a threshold power associated with the FD mode of operation. In some aspects, the set of values may include a third value indicating a power headroom (PH) associated with the HD mode of operation. The set of values, in some aspects, may include a fourth value indicating an additional PH associated with the FD mode of operation. In some aspects, the set of values may be associated with a slot configured for SBFD operation and the set of values may further include an indication of an active mode of operation at the UE, where the active mode of operation is the HD mode of operation. The set of values, in some aspects, may include a third value indicating a power headroom (PH) associated with an active mode of operation the active mode of operation is one of the FD mode of operation or the HD mode of operation. In some aspects, the set of values further may include a fifth value, where the fifth value indicates that the active mode of operation is the FD mode of operation or the fifth value indicates that the active mode of operation is the HD mode of operation. The set of values, in some aspects, may include a fifth value indicating a PH associated with a time division duplex (TDD) mode of operation and a sixth value indicating a Pₘₐₓ associated with the TDD mode of operation. In some aspects, the set of values may be a first set of values associated with a first cell and the report may further include an additional set of values associated with a corresponding additional cell, and where the additional set of values may include at least a third value indicating a third Pₘₐₓ associated with the FD mode of operation at the UE and a fourth value indicating a fourth Pₘₐₓ associated with the HD mode of operation at the UE. In some aspects, one of the first value and the second value may include a joint indication associated with both the FD mode of operation and the HD mode of operation, where one of the first value and the second value may include a single-mode indication associated with one of the FD mode of operation or the HD mode of operation, and where the joint indication and the single-mode indication together indicate the first Pₘₐₓ, the second Pₘₐₓ, a first power headroom (PH) associated with the FD mode of operation, and a second PH associated with the HD mode of operation. The set of values, in some aspects, may include a third value indicating a first power headroom (PH) associated with the half-duplex (HD) mode of operation at the UE, where the first value indicates may include an indication of whether a second PH associated with the FD mode of operation is within a threshold power of the first PH, where the first Pₘₐₓ is related to the second PH.

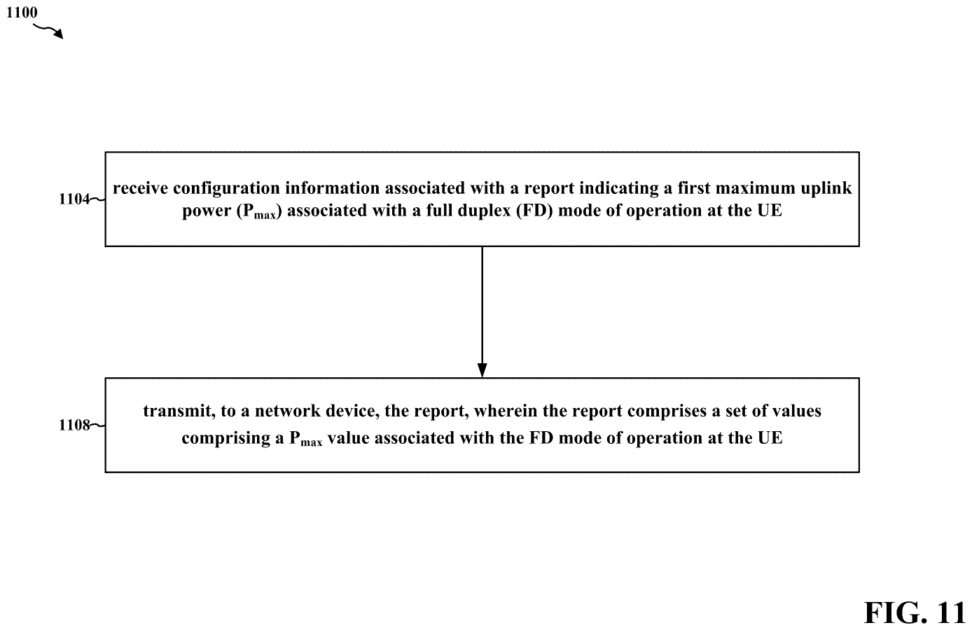

FIG. 11 is a flowchart 1100 of a method of wireless communication. The method may be performed by a UE (e.g., the UE 104; the apparatus 1504). In some aspects, the UE may transmit at least one of: a first indication of support for the report indicating the Pₘₐₓ and a second indication of support for measuring the SI during downlink reception; or a combined indication of support for the report indicating the Pₘₐₓ and support for measuring the SI during downlink reception. For example, referring to FIG. 10, the UE 1004 may transmit one or more UE capability indications 1010.

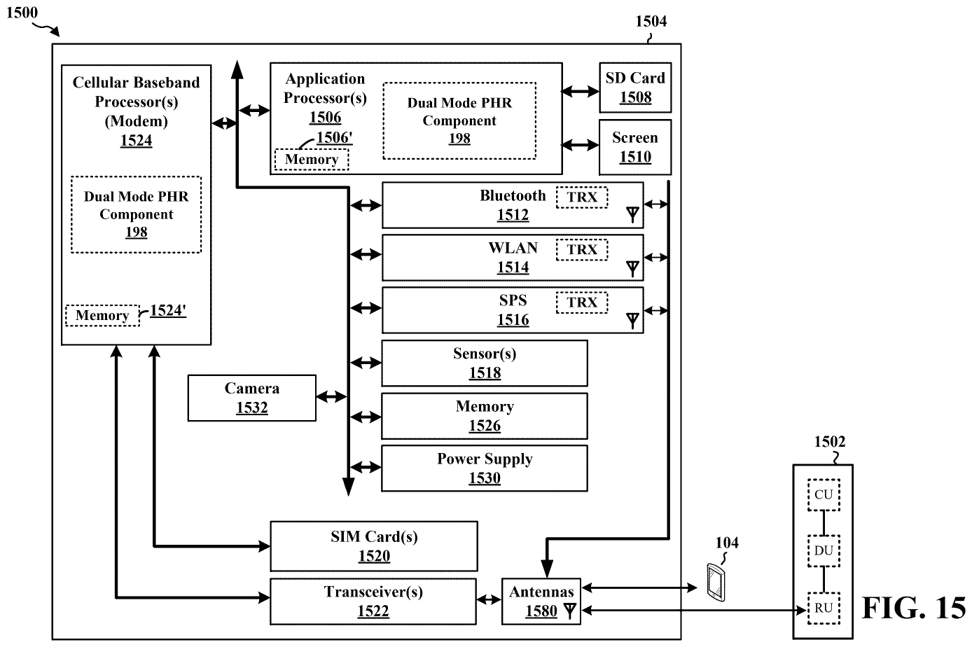

At 1104, the UE may receive configuration information associated with a report indicating a maximum uplink power (Pₘₐₓ) associated with a full duplex (FD) mode of operation at the UE. For example, 1104 may be performed by application processor(s) 1506, cellular baseband processor(s) 1524, transceiver(s) 1522, antenna(s) 1580, and/or dual mode PHR component 198 of FIG. 15. In some aspects, the configuration information may indicate whether the set of values includes a single power headroom (PH) value associated with one of a half-duplex (HD) mode of operation at the UE or the FD mode of operation at the UE or the set of values includes a first PH value associated with the HD mode of operation, a second Pₘₐₓ value associated with the HD mode of operation at the UE, and a second PH value associated with the FD mode of operation. The configuration information, in some aspects, may indicate whether the set of values includes a third PH value associated with a time division duplex (TDD) mode of operation and a third Pₘₐₓ value associated with the TDD mode of operation. In some aspects, the configuration may include an indication of resources for measuring a SI at the UE. The resources, in some aspects, may include resources for measuring a combination of CLI and the SI. In some aspects, the resources for measuring the SI may include a first set of measurement resources that overlap in both time and frequency with a first uplink transmission from the UE for measuring the SI and a second set of measurement resources that do not overlap in both time and frequency with any uplink transmission from the UE for measurement of inter-cell interference. In some aspects, the configuration information may indicate whether the set of values includes a (fourth) value indicating a PH associated with an inactive mode of operation, where the active mode of operation is one of the FD mode of operation or the HD mode of operation. In some aspects, the configuration information may indicate (e.g., via a twoPHRmode parameter) whether the set of (reported) values includes a (fifth) value indicating a PH (or PH value) associated with a TDD mode of operation and a (sixth) value indicating a Pₘₐₓ associated with the TDD mode of operation. The configuration information, in some aspects, may include an indication of resources for measuring a self-interference (SI) at the UE. The configuration information, in some aspects, may include an indication of resources for measuring a cross-cell interference at the UE. The resources for measuring the SI, in some aspects, may include a first set of measurement resources that overlap in both time and frequency with a first uplink transmission from the UE for measuring the SI and a second set of measurement resources that do not overlap in both time and frequency with any uplink transmission from the UE for measurement of inter-cell interference. In some aspects, the first set of measurement resources and the first uplink transmission overlap with the second set of measurement resources in time and do not overlap with the second set of measurement resources in frequency. For example, referring to FIG. 10, the UE 1004 may receive a Pₘₐₓ/PHR reporting configuration 1012.

In some aspects, the UE may measure the SI at the UE, based on the indication of the resources for measuring the self-interference at the UE. In some aspects, measuring the self-interference at the UE may include measuring the first uplink transmission that is one of a reference signal transmission or a dummy transmission scheduled to overlap with the first set of measurement resources. For example, referring to FIG. 10, the UE 1004 may, at 1018, receive the UL transmission 1014 and measure the SI based on the UL transmission 1014. The UE 1004, at 1018, may also measure CLI based on UL transmission 1016 from one or more additional UEs 1003.

At 1108, the UE may transmit, to a network device, the report. In some aspects, the report may include a set of values including a Pₘₐₓ value associated with the FD mode of operation at the UE. The set of values, in some aspects, may include a PH value associated with the FD mode of operation at the UE. In some aspects, the report may include a single-bit indication that the PH value is associated with the FD mode of operation at the UE. The Pₘₐₓ value may be a first Pₘₐₓ value, and the set of values may include a second Pₘₐₓ value associated with the HD mode of operation at the UE and a PH value associated with the HD mode of operation. In some aspects, the report may include a single-bit indication that the PH value is associated with the HD mode of operation at the UE. The set of values, in some aspects, may further include an additional indication that the first Pₘₐₓ value is included in the set of values. In some aspects, the set of values may be associated with a slot configured for SBFD operation and the set of values may include an indication of an active mode of operation at the UE. The Pₘₐₓ value, in some aspects, may be a first Pₘₐₓ value, and the configuration 1012 further indicates whether the set of values includes a single PH value associated with one of a HD mode of operation at the UE or the FD mode of operation at the UE or the set of values includes a first PH value associated with the HD mode of operation, a second Pₘₐₓ value associated with the HD mode of operation at the UE, and a second PH value associated with the FD mode of operation. In some aspects, the configuration information further indicates whether the set of values includes a third PH value associated with a time division duplex (TDD) mode of operation and a third Pₘₐₓ value associated with the TDD mode of operation. The Pₘₐₓ value, in some aspects, may be a first Pₘₐₓ value, and the set of values may be a first set of values associated with a first cell and the report may include an additional set of values associated with a corresponding additional cell, and the additional set of values may include at least a second Pₘₐₓ value associated with the FD mode of operation at the UE. In some aspects, the set of values may include a PH value, at least one of the Pₘₐₓ value or the PH value may be a joint indication associated with both the FD mode of operation and a HD mode of operation at the UE. One of the Pₘₐₓ value or the PH value, in some aspects may include a single-mode indication associated with one of the FD mode of operation or the HD mode of operation at the UE, and the joint indication and the single-mode indication together indicate a first Pₘₐₓ value associated with the FD mode of operation at the UE, a second Pₘₐₓ value associated with the HD mode of operation at the UE, a first PH value associated with the FD mode of operation at the UE, and a second PH value associated with the HD mode of operation at the UE. In some aspects, the Pₘₐₓ value may be a first Pₘₐₓ value, and the set of values may include a first PH value associated with a HD mode of operation at the UE and a second Pₘₐₓ value associated with the HD mode of operation at the UE, and the set of values may include an additional value indicating whether a second PH associated with the FD mode of operation at the UE is within a threshold power of the first PH. The report, in some aspects, may be associated with one of a layer 2 (L2) signaling for reporting at least the Pₘₐₓ value associated with the FD mode of operation based on the SI measured at the UE or a layer 1 (L1) signaling for reporting at least the Pₘₐₓ value associated with the FD mode of operation based on the SI measured at the UE. In some aspects, the Pₘₐₓ may be based on a maximum power reduction for meeting a threshold power associated with the FD mode of operation.

In some aspects, the report may include a set of values including a first value indicating the first Pₘₐₓ and a second value indicating a second Pₘₐₓ associated with a half-duplex (HD) mode of operation at the UE. For example, 1108 may be performed by application processor(s) 1506, cellular baseband processor(s) 1524, transceiver(s) 1522, antenna(s) 1580, and/or dual mode PHR component 198 of FIG. 15. In some aspects, the set of values is based, at least in part, on the SI measured at the UE. In some aspects, the set of values may include a third value indicating a power headroom (PH) associated with the HD mode of operation. The set of values, in some aspects, may include a fourth value indicating an additional PH associated with the FD mode of operation. In some aspects, the set of values may be associated with a slot configured for SBFD operation and the set of values may further include an indication of an active mode of operation at the UE, where the active mode of operation is the HD mode of operation. The set of values, in some aspects, may include a third value indicating a power headroom (PH) associated with an active mode of operation the active mode of operation is one of the FD mode of operation or the HD mode of operation. In some aspects, the set of values further may include a fifth value, where the fifth value indicates that the active mode of operation is the FD mode of operation or the fifth value indicates that the active mode of operation is the HD mode of operation. The set of values, in some aspects, may include a fifth value indicating a PH associated with a time division duplex (TDD) mode of operation and a sixth value indicating a Pₘₐₓ associated with the TDD mode of operation. In some aspects, the set of values may be a first set of values associated with a first cell and the report may further include an additional set of values associated with a corresponding additional cell, and where the additional set of values may include at least a third value indicating a third Pₘₐₓ associated with the FD mode of operation at the UE and a fourth value indicating a fourth Pₘₐₓ associated with the HD mode of operation at the UE. In some aspects, one of the first value and the second value may include a joint indication associated with both the FD mode of operation and the HD mode of operation, where one of the first value and the second value may include a single-mode indication associated with one of the FD mode of operation or the HD mode of operation, and where the joint indication and the single-mode indication together indicate the first Pₘₐₓ, the second Pₘₐₓ, a first power headroom (PH) associated with the FD mode of operation, and a second PH associated with the HD mode of operation. The set of values, in some aspects, may include a third value indicating a first power headroom (PH) associated with the half-duplex (HD) mode of operation at the UE, where the first value indicates may include an indication of whether a second PH associated with the FD mode of operation is within a threshold power of the first PH, where the first Pₘₐₓ is related to the second PH. In some aspects, the report includes a set of values including a first value associated with a maximum uplink power and a second value associated with a power headroom (PH), where one of the first value and the second value includes a joint indication associated with both the FD mode of operation and the HD mode of operation, where one of the first value and the second value includes a single-mode indication associated with one of the FD mode of operation or the HD mode of operation, and where the joint indication when combined with the single-mode indication indicate the first Pₘₐₓ and the second Pₘₐₓ and a first PH associated with the FD mode of operation and a second PH associated with the HD mode of operation. The report, in some aspects, may include a set of values including at least a first value indicating the second PH and a second value indicating whether the first PH is within a threshold power of the second PH. In some aspects, the report may include at least a first value indicating the first Pₘₐₓ, where the first Pₘₐₓ is based on at least one measure of self-interference. For example, referring to FIG. 10, the UE 1004 may, at 1018, receive the UL transmission 1014 and measure the SI based on the UL transmission 1014. The UE 1004 may transmit an indication 1020 of one or more of the Pₘₐₓ and PH determined at 1018.

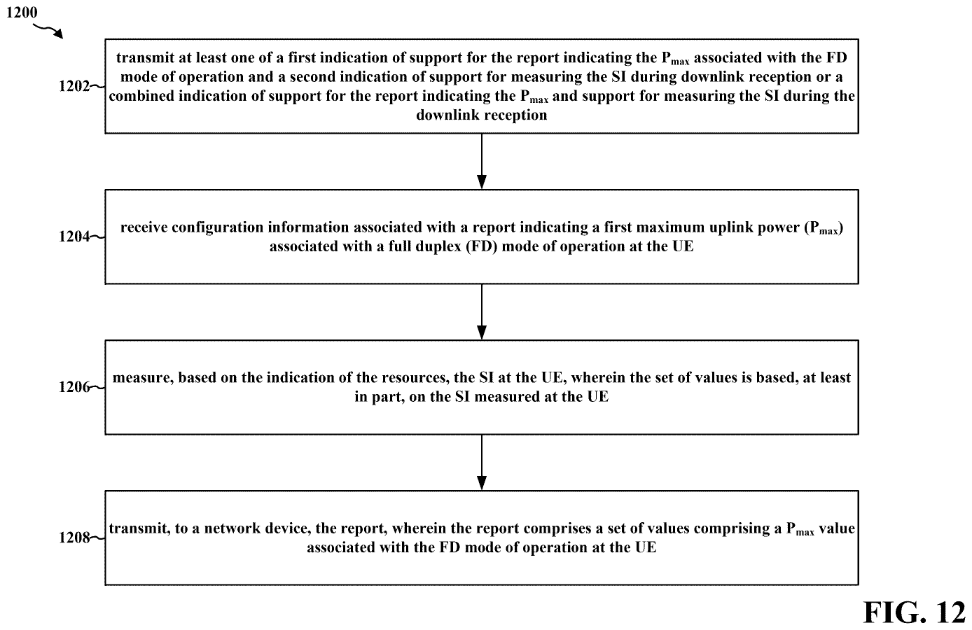

FIG. 12 is a flowchart 1200 of a method of wireless communication. The method may be performed by a UE (e.g., the UE 104; the apparatus 1504). At 1202, the UE may transmit at least one of: a first indication of support for the report indicating the Pₘₐₓ and a second indication of support for measuring the SI during downlink reception; or a combined indication of support for the report indicating the Pₘₐₓ and support for measuring the SI during downlink reception. For example, 1202 may be performed by application processor(s) 1506, cellular baseband processor(s) 1524, transceiver(s) 1522, antenna(s) 1580, and/or dual mode PHR component 198 of FIG. 15. For example, referring to FIG. 10, the UE 1004 may transmit one or more UE capability indications 1010.

At 1204, the UE may receive configuration information associated with a report indicating a maximum uplink power (Pₘₐₓ) associated with a full duplex (FD) mode of operation at the UE. For example, 1204 may be performed by application processor(s) 1506, cellular baseband processor(s) 1524, transceiver(s) 1522, antenna(s) 1580, and/or dual mode PHR component 198 of FIG. 15. In some aspects, the configuration information may indicate whether the set of values includes a single power headroom (PH) value associated with one of a half-duplex (HD) mode of operation at the UE or the FD mode of operation at the UE or the set of values includes a first PH value associated with the HD mode of operation, a second Pₘₐₓ value associated with the HD mode of operation at the UE, and a second PH value associated with the FD mode of operation. The configuration information, in some aspects, may indicate whether the set of values includes a third PH value associated with a time division duplex (TDD) mode of operation and a third Pₘₐₓ value associated with the TDD mode of operation. In some aspects, the configuration may include an indication of resources for measuring a SI at the UE. The resources, in some aspects, may include resources for measuring a combination of CLI and the SI. In some aspects, the resources for measuring the SI may include a first set of measurement resources that overlap in both time and frequency with a first uplink transmission from the UE for measuring the SI and a second set of measurement resources that do not overlap in both time and frequency with any uplink transmission from the UE for measurement of inter-cell interference. In some aspects, the configuration information may indicate whether the set of values includes a (fourth) value indicating a PH associated with an inactive mode of operation, where the active mode of operation is one of the FD mode of operation or the HD mode of operation. In some aspects, the configuration information may indicate (e.g., via a twoPHRmode parameter) whether the set of (reported) values includes a (fifth) value indicating a PH (or PH value) associated with a TDD mode of operation and a (sixth) value indicating a Pₘₐₓ associated with the TDD mode of operation. The configuration information, in some aspects, may include an indication of resources for measuring a self-interference (SI) at the UE. The configuration information, in some aspects, may include an indication of resources for measuring a cross-cell interference at the UE. The resources for measuring the SI, in some aspects, may include a first set of measurement resources that overlap in both time and frequency with a first uplink transmission from the UE for measuring the SI and a second set of measurement resources that do not overlap in both time and frequency with any uplink transmission from the UE for measurement of inter-cell interference. In some aspects, the first set of measurement resources and the first uplink transmission overlap with the second set of measurement resources in time and do not overlap with the second set of measurement resources in frequency. For example, referring to FIG. 10, the UE 1004 may receive a Pₘₐₓ/PHR reporting configuration 1012.

At 1206, the UE may measure the SI at the UE, based on the indication of the resources for measuring the self-interference at the UE. For example, 1206 may be performed by application processor(s) 1506, cellular baseband processor(s) 1524, transceiver(s) 1522, antenna(s) 1580, and/or dual mode PHR component 198 of FIG. 15. In some aspects, measuring the self-interference at the UE may include measuring the first uplink transmission that is one of a reference signal transmission or a dummy transmission scheduled to overlap with the first set of measurement resources. For example, referring to FIG. 10, the UE 1004 may, at 1018, receive the UL transmission 1014 and measure the SI based on the UL transmission 1014. The UE 1004, at 1018, may also measure CLI based on UL transmission 1016 from one or more additional UEs 1003.

At 1208, the UE may transmit, to a network device, the report. In some aspects, the report may include a set of values including a Pₘₐₓ value associated with the FD mode of operation at the UE. The set of values, in some aspects, may include a PH value associated with the FD mode of operation at the UE. In some aspects, the report may include a single-bit indication that the PH value is associated with the FD mode of operation at the UE. The Pₘₐₓ value may be a first Pₘₐₓ value, and the set of values may include a second Pₘₐₓ value associated with the HD mode of operation at the UE and a PH value associated with the HD mode of operation. In some aspects, the report may include a single-bit indication that the PH value is associated with the HD mode of operation at the UE. The set of values, in some aspects, may further include an additional indication that the first Pₘₐₓ value is included in the set of values. In some aspects, the set of values may be associated with a slot configured for SBFD operation and the set of values may include an indication of an active mode of operation at the UE. The Pₘₐₓ value, in some aspects, may be a first Pₘₐₓ value, and the configuration 1012 further indicates whether the set of values includes a single PH value associated with one of a HD mode of operation at the UE or the FD mode of operation at the UE or the set of values includes a first PH value associated with the HD mode of operation, a second Pₘₐₓ value associated with the HD mode of operation at the UE, and a second PH value associated with the FD mode of operation. In some aspects, the configuration information further indicates whether the set of values includes a third PH value associated with a time division duplex (TDD) mode of operation and a third Pₘₐₓ value associated with the TDD mode of operation. The Pₘₐₓ value, in some aspects, may be a first Pₘₐₓ value, and the set of values may be a first set of values associated with a first cell and the report may include an additional set of values associated with a corresponding additional cell, and the additional set of values may include at least a second Pₘₐₓ value associated with the FD mode of operation at the UE. In some aspects, the set of values may include a PH value, at least one of the Pₘₐₓ value or the PH value may be a joint indication associated with both the FD mode of operation and a HD mode of operation at the UE. One of the Pₘₐₓ value or the PH value, in some aspects may include a single-mode indication associated with one of the FD mode of operation or the HD mode of operation at the UE, and the joint indication and the single-mode indication together indicate a first Pₘₐₓ value associated with the FD mode of operation at the UE, a second Pₘₐₓ value associated with the HD mode of operation at the UE, a first PH value associated with the FD mode of operation at the UE, and a second PH value associated with the HD mode of operation at the UE. In some aspects, the Pₘₐₓ value may be a first Pₘₐₓ value, and the set of values may include a first PH value associated with a HD mode of operation at the UE and a second Pₘₐₓ value associated with the HD mode of operation at the UE, and the set of values may include an additional value indicating whether a second PH associated with the FD mode of operation at the UE is within a threshold power of the first PH. The report, in some aspects, may be associated with one of a layer 2 (L2) signaling for reporting at least the Pₘₐₓ value associated with the FD mode of operation based on the SI measured at the UE or a layer 1 (L1) signaling for reporting at least the Pₘₐₓ value associated with the FD mode of operation based on the SI measured at the UE. In some aspects, the Pₘₐₓ may be based on a maximum power reduction for meeting a threshold power associated with the FD mode of operation.

In some aspects, the report may include a set of values including a first value indicating the first Pₘₐₓ and a second value indicating a second Pₘₐₓ associated with a half-duplex (HD) mode of operation at the UE. For example, 1208 may be performed by application processor(s) 1506, cellular baseband processor(s) 1524, transceiver(s) 1522, antenna(s) 1580, and/or dual mode PHR component 198 of FIG. 15. In some aspects, the set of values is based, at least in part, on the SI measured at the UE. In some aspects, the set of values may include a third value indicating a power headroom (PH) associated with the HD mode of operation. The set of values, in some aspects, may include a fourth value indicating an additional PH associated with the FD mode of operation. In some aspects, the set of values may be associated with a slot configured for SBFD operation and the set of values may further include an indication of an active mode of operation at the UE, where the active mode of operation is the HD mode of operation. The set of values, in some aspects, may include a third value indicating a power headroom (PH) associated with an active mode of operation the active mode of operation is one of the FD mode of operation or the HD mode of operation. In some aspects, the set of values further may include a fifth value, where the fifth value indicates that the active mode of operation is the FD mode of operation or the fifth value indicates that the active mode of operation is the HD mode of operation. The set of values, in some aspects, may include a fifth value indicating a PH associated with a time division duplex (TDD) mode of operation and a sixth value indicating a Pₘₐₓ associated with the TDD mode of operation. In some aspects, the set of values may be a first set of values associated with a first cell and the report may further include an additional set of values associated with a corresponding additional cell, and where the additional set of values may include at least a third value indicating a third Pₘₐₓ associated with the FD mode of operation at the UE and a fourth value indicating a fourth Pₘₐₓ associated with the HD mode of operation at the UE. In some aspects, one of the first value and the second value may include a joint indication associated with both the FD mode of operation and the HD mode of operation, where one of the first value and the second value may include a single-mode indication associated with one of the FD mode of operation or the HD mode of operation, and where the joint indication and the single-mode indication together indicate the first Pₘₐₓ, the second Pₘₐₓ, a first power headroom (PH) associated with the FD mode of operation, and a second PH associated with the HD mode of operation. The set of values, in some aspects, may include a third value indicating a first power headroom (PH) associated with the half-duplex (HD) mode of operation at the UE, where the first value indicates may include an indication of whether a second PH associated with the FD mode of operation is within a threshold power of the first PH, where the first Pₘₐₓ is related to the second PH. In some aspects, the report includes a set of values including a first value associated with a maximum uplink power and a second value associated with a power headroom (PH), where one of the first value and the second value includes a joint indication associated with both the FD mode of operation and the HD mode of operation, where one of the first value and the second value includes a single-mode indication associated with one of the FD mode of operation or the HD mode of operation, and where the joint indication when combined with the single-mode indication indicate the first Pₘₐₓ and the second Pₘₐₓ and a first PH associated with the FD mode of operation and a second PH associated with the HD mode of operation. The report, in some aspects, may include a set of values including at least a first value indicating the second PH and a second value indicating whether the first PH is within a threshold power of the second PH. In some aspects, the report may include at least a first value indicating the first Pₘₐₓ, where the first Pₘₐₓ is based on at least one measure of self-interference. For example, referring to FIG. 10, the UE 1004 may, at 1018, receive the UL transmission 1014 and measure the SI based on the UL transmission 1014. The UE 1004 may transmit an indication 1020 of one or more of the Pₘₐₓ and PH determined at 1018.

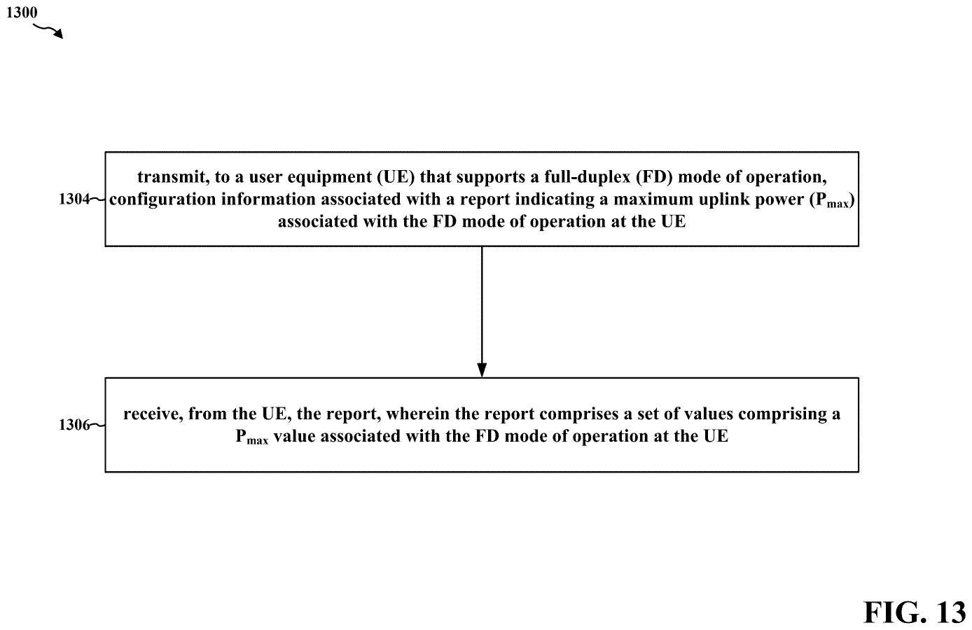

FIG. 13 is a flowchart 1300 of a method of wireless communication. The method may be performed by a network device such as a base station (e.g., the base station 102; the network entity 1502, 1602). In some aspects, the network device may receive at least one of a first indication of support for the report indicating the Pₘₐₓ and a second indication of support for measuring the SI during downlink reception, or a combined indication of support for the report indicating the Pₘₐₓ and support for measuring the SI during downlink reception. For example, referring to FIG. 10, the base station 1002 may receive one or more UE capability indications 1010.

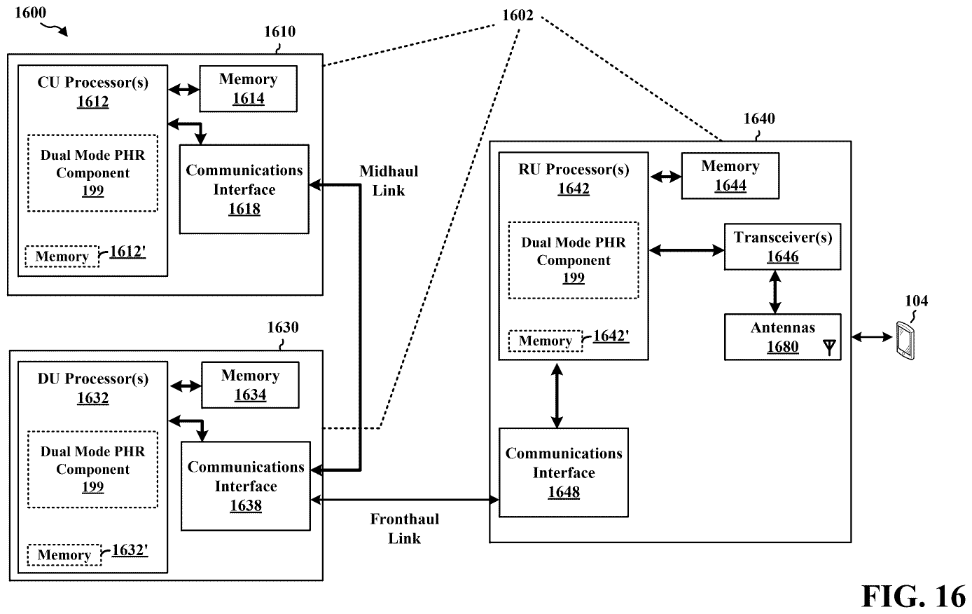

At 1304, the network device may transmit, to a UE that supports a full-duplex (FD) mode of operation, configuration information associated with a report indicating a maximum uplink power (Pₘₐₓ) associated with the FD mode of operation at the UE. For example, 1304 may be performed by CU processor(s) 1612, DU processor(s) 1632, RU processor(s) 1642, transceiver(s) 1646, antenna(s) 1680, and/or dual mode PHR component 199 of FIG. 16. In some aspects, the configuration information may indicate whether the set of values includes a single power headroom (PH) value associated with one of a half-duplex (HD) mode of operation at the UE or the FD mode of operation at the UE or the set of values includes a first PH value associated with the HD mode of operation, a second Pₘₐₓ value associated with the HD mode of operation at the UE, and a second PH value associated with the FD mode of operation. The configuration information, in some aspects, may indicate whether the set of values includes a third PH value associated with a time division duplex (TDD) mode of operation and a third Pₘₐₓ value associated with the TDD mode of operation. In some aspects, the configuration may include an indication of resources for measuring a SI at the UE. The resources, in some aspects, may include resources for measuring a combination of CLI and the SI. In some aspects, the resources for measuring the SI may include a first set of measurement resources that overlap in both time and frequency with a first uplink transmission from the UE for measuring the SI and a second set of measurement resources that do not overlap in both time and frequency with any uplink transmission from the UE for measurement of inter-cell interference. In some aspects, the configuration information may indicate whether the set of values includes a (fourth) value indicating a PH associated with an inactive mode of operation, where the active mode of operation is one of the FD mode of operation or the HD mode of operation. In some aspects, the configuration information may indicate (e.g., via a twoPHRmode parameter) whether the set of (reported) values includes a (fifth) value indicating a PH (or PH value) associated with a TDD mode of operation and a (sixth) value indicating a Pₘₐₓ associated with the TDD mode of operation. The configuration information, in some aspects, may include an indication of resources for measuring a self-interference (SI) at the UE. The configuration information, in some aspects, may include an indication of resources for measuring a cross-cell interference at the UE. The resources for measuring the SI, in some aspects, may include a first set of measurement resources that overlap in both time and frequency with a first uplink transmission from the UE for measuring the SI and a second set of measurement resources that do not overlap in both time and frequency with any uplink transmission from the UE for measurement of inter-cell interference. In some aspects, the first set of measurement resources and the first uplink transmission overlap with the second set of measurement resources in time and do not overlap with the second set of measurement resources in frequency. For example, referring to FIG. 10, the base station 1002 may transmit a Pₘₐₓ/PHR reporting configuration 1012.

At 1306, the network device may receive, from the UE, the report. In some aspects, the report may include a set of values including a Pₘₐₓ value associated with the FD mode of operation at the UE. The set of values, in some aspects, may include a PH value associated with the FD mode of operation at the UE. In some aspects, the report may include a single-bit indication that the PH value is associated with the FD mode of operation at the UE. The Pₘₐₓ value may be a first Pₘₐₓ value, and the set of values may include a second Pₘₐₓ value associated with the HD mode of operation at the UE and a PH value associated with the HD mode of operation. In some aspects, the report may include a single-bit indication that the PH value is associated with the HD mode of operation at the UE. The set of values, in some aspects, may further include an additional indication that the first Pₘₐₓ value is included in the set of values. In some aspects, the set of values may be associated with a slot configured for SBFD operation and the set of values may include an indication of an active mode of operation at the UE. The Pₘₐₓ value, in some aspects, may be a first Pₘₐₓ value, and the configuration 1012 further indicates whether the set of values includes a single PH value associated with one of a HD mode of operation at the UE or the FD mode of operation at the UE or the set of values includes a first PH value associated with the HD mode of operation, a second Pₘₐₓ value associated with the HD mode of operation at the UE, and a second PH value associated with the FD mode of operation. In some aspects, the configuration information further indicates whether the set of values includes a third PH value associated with a time division duplex (TDD) mode of operation and a third Pₘₐₓ value associated with the TDD mode of operation. The Pₘₐₓ value, in some aspects, may be a first Pₘₐₓ value, and the set of values may be a first set of values associated with a first cell and the report may include an additional set of values associated with a corresponding additional cell, and the additional set of values may include at least a second Pₘₐₓ value associated with the FD mode of operation at the UE. In some aspects, the set of values may include a PH value, at least one of the Pₘₐₓ value or the PH value may be a joint indication associated with both the FD mode of operation and a HD mode of operation at the UE. One of the Pₘₐₓ value or the PH value, in some aspects may include a single-mode indication associated with one of the FD mode of operation or the HD mode of operation at the UE, and the joint indication and the single-mode indication together indicate a first Pₘₐₓ value associated with the FD mode of operation at the UE, a second Pₘₐₓ value associated with the HD mode of operation at the UE, a first PH value associated with the FD mode of operation at the UE, and a second PH value associated with the HD mode of operation at the UE. In some aspects, the Pₘₐₓ value may be a first Pₘₐₓ value, and the set of values may include a first PH value associated with a HD mode of operation at the UE and a second Pₘₐₓ value associated with the HD mode of operation at the UE, and the set of values may include an additional value indicating whether a second PH associated with the FD mode of operation at the UE is within a threshold power of the first PH. The report, in some aspects, may be associated with one of a layer 2 (L2) signaling for reporting at least the Pₘₐₓ value associated with the FD mode of operation based on the SI measured at the UE or a layer 1 (L1) signaling for reporting at least the Pₘₐₓ value associated with the FD mode of operation based on the SI measured at the UE. In some aspects, the Pₘₐₓ may be based on a maximum power reduction for meeting a threshold power associated with the FD mode of operation.

In some aspects, the report may include a set of values including a first value indicating the first Pₘₐₓ and a second value indicating a second Pₘₐₓ associated with a half-duplex (HD) mode of operation at the UE. For example, 1306 may be performed by CU processor(s) 1612, DU processor(s) 1632, RU processor(s) 1642, transceiver(s) 1646, antenna(s) 1680, and/or dual mode PHR component 199 of FIG. 16. In some aspects, the set of values may include a third value indicating a power headroom (PH) associated with the HD mode of operation. The set of values, in some aspects, may include a fourth value indicating an additional PH associated with the FD mode of operation. In some aspects, the set of values may be associated with a slot configured for SBFD operation and the set of values may further include an indication of an active mode of operation at the UE, where the active mode of operation is the HD mode of operation. The set of values, in some aspects, may include a third value indicating a power headroom (PH) associated with an active mode of operation the active mode of operation is one of the FD mode of operation or the HD mode of operation. In some aspects, the set of values further may include a fifth value, where the fifth value indicates that the active mode of operation is the FD mode of operation or the fifth value indicates that the active mode of operation is the HD mode of operation. The set of values, in some aspects, may include a fifth value indicating a PH associated with a time division duplex (TDD) mode of operation and a sixth value indicating a Pₘₐₓ associated with the TDD mode of operation. In some aspects, the set of values may be a first set of values associated with a first cell and the report may further include an additional set of values associated with a corresponding additional cell, and where the additional set of values may include at least a third value indicating a third Pₘₐₓ associated with the FD mode of operation at the UE and a fourth value indicating a fourth Pₘₐₓ associated with the HD mode of operation at the UE. In some aspects, one of the first value and the second value may include a joint indication associated with both the FD mode of operation and the HD mode of operation, where one of the first value and the second value may include a single-mode indication associated with one of the FD mode of operation or the HD mode of operation, and where the joint indication and the single-mode indication together indicate the first Pₘₐₓ, the second Pₘₐₓ, a first power headroom (PH) associated with the FD mode of operation, and a second PH associated with the HD mode of operation. The set of values, in some aspects, may include a third value indicating a first power headroom (PH) associated with the half-duplex (HD) mode of operation at the UE, where the first value indicates may include an indication of whether a second PH associated with the FD mode of operation is within a threshold power of the first PH, where the first Pₘₐₓ is related to the second PH. In some aspects, the report includes a set of values including a first value associated with a maximum uplink power and a second value associated with a power headroom (PH), where one of the first value and the second value includes a joint indication associated with both the FD mode of operation and the HD mode of operation, where one of the first value and the second value includes a single-mode indication associated with one of the FD mode of operation or the HD mode of operation, and where the joint indication when combined with the single-mode indication indicate the first Pₘₐₓ and the second Pₘₐₓ and a first PH associated with the FD mode of operation and a second PH associated with the HD mode of operation. The report, in some aspects, may include a set of values including at least a first value indicating the second PH and a second value indicating whether the first PH is within a threshold power of the second PH. In some aspects, the report may include at least a first value indicating the first Pₘₐₓ, where the first Pₘₐₓ is based on at least one measure of self-interference. For example, referring to FIG. 10, the base station 1002 may receive transmit an indication 1020 of one or more of the Pₘₐₓ and PH.

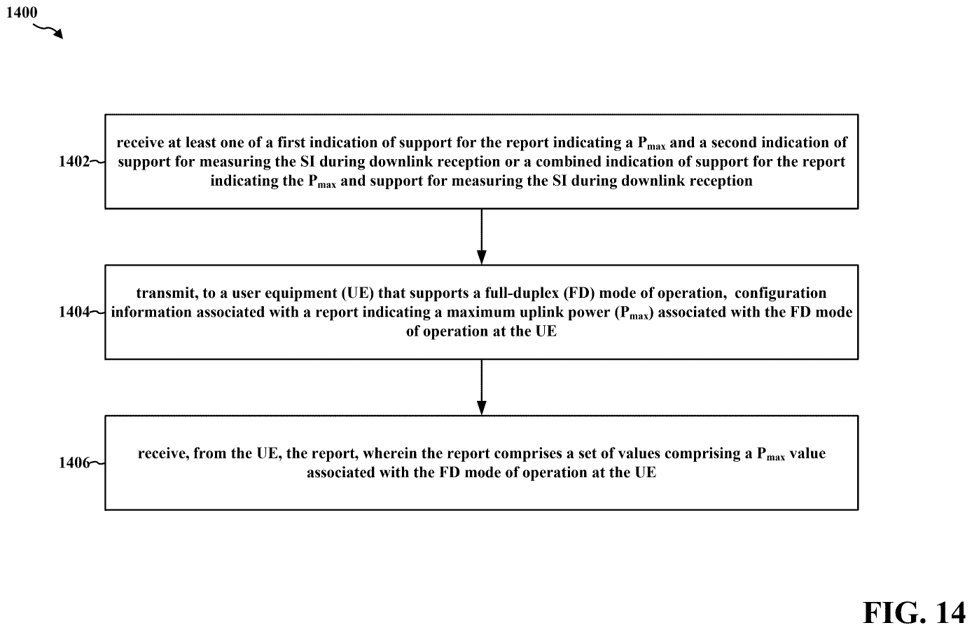

FIG. 14 is a flowchart 1400 of a method of wireless communication. The method may be performed by a network device such as a base station (e.g., the base station 102; the network entity 1502, 1602). At 1402, the network device may receive at least one of a first indication of support for the report indicating the Pₘₐₓ and a second indication of support for measuring the SI during downlink reception, or a combined indication of support for the report indicating the Pₘₐₓ and support for measuring the SI during downlink reception. For example, 1402 may be performed by CU processor(s) 1612, DU processor(s) 1632, RU processor(s) 1642, transceiver(s) 1646, antenna(s) 1680, and/or dual mode PHR component 199 of FIG. 16. For example, referring to FIG. 10, the base station 1002 may receive one or more UE capability indications 1010.

At 1404, the network device may transmit, to a UE that supports a full-duplex (FD) mode of operation, configuration information associated with a report indicating a maximum uplink power (Pₘₐₓ) associated with the FD mode of operation at the UE. For example, 1404 may be performed by CU processor(s) 1612, DU processor(s) 1632, RU processor(s) 1642, transceiver(s) 1646, antenna(s) 1680, and/or dual mode PHR component 199 of FIG. 16. In some aspects, the configuration information may indicate whether the set of values includes a single power headroom (PH) value associated with one of a half-duplex (HD) mode of operation at the UE or the FD mode of operation at the UE or the set of values includes a first PH value associated with the HD mode of operation, a second Pₘₐₓ value associated with the HD mode of operation at the UE, and a second PH value associated with the FD mode of operation. The configuration information, in some aspects, may indicate whether the set of values includes a third PH value associated with a time division duplex (TDD) mode of operation and a third Pₘₐₓ value associated with the TDD mode of operation. In some aspects, the configuration may include an indication of resources for measuring a SI at the UE. The resources, in some aspects, may include resources for measuring a combination of CLI and the SI. In some aspects, the resources for measuring the SI may include a first set of measurement resources that overlap in both time and frequency with a first uplink transmission from the UE for measuring the SI and a second set of measurement resources that do not overlap in both time and frequency with any uplink transmission from the UE for measurement of inter-cell interference. In some aspects, the configuration information may indicate whether the set of values includes a (fourth) value indicating a PH associated with an inactive mode of operation, where the active mode of operation is one of the FD mode of operation or the HD mode of operation. In some aspects, the configuration information may indicate (e.g., via a twoPHRmode parameter) whether the set of (reported) values includes a (fifth) value indicating a PH (or PH value) associated with a TDD mode of operation and a (sixth) value indicating a Pₘₐₓ associated with the TDD mode of operation. The configuration information, in some aspects, may include an indication of resources for measuring a self-interference (SI) at the UE. The configuration information, in some aspects, may include an indication of resources for measuring a cross-cell interference at the UE. The resources for measuring the SI, in some aspects, may include a first set of measurement resources that overlap in both time and frequency with a first uplink transmission from the UE for measuring the SI and a second set of measurement resources that do not overlap in both time and frequency with any uplink transmission from the UE for measurement of inter-cell interference. In some aspects, the first set of measurement resources and the first uplink transmission overlap with the second set of measurement resources in time and do not overlap with the second set of measurement resources in frequency. For example, referring to FIG. 10, the base station 1002 may transmit a Pₘₐₓ/PHR reporting configuration 1012.

At 1406, the network device may receive, from the UE, the report. In some aspects, the report may include a set of values including a Pₘₐₓ value associated with the FD mode of operation at the UE. The set of values, in some aspects, may include a PH value associated with the FD mode of operation at the UE. In some aspects, the report may include a single-bit indication that the PH value is associated with the FD mode of operation at the UE. The Pₘₐₓ value may be a first Pₘₐₓ value, and the set of values may include a second Pₘₐₓ value associated with the HD mode of operation at the UE and a PH value associated with the HD mode of operation. In some aspects, the report may include a single-bit indication that the PH value is associated with the HD mode of operation at the UE. The set of values, in some aspects, may further include an additional indication that the first Pₘₐₓ value is included in the set of values. In some aspects, the set of values may be associated with a slot configured for SBFD operation and the set of values may include an indication of an active mode of operation at the UE. The Pₘₐₓ value, in some aspects, may be a first Pₘₐₓ value, and the configuration 1012 further indicates whether the set of values includes a single PH value associated with one of a HD mode of operation at the UE or the FD mode of operation at the UE or the set of values includes a first PH value associated with the HD mode of operation, a second Pₘₐₓ value associated with the HD mode of operation at the UE, and a second PH value associated with the FD mode of operation. In some aspects, the configuration information further indicates whether the set of values includes a third PH value associated with a time division duplex (TDD) mode of operation and a third Pₘₐₓ value associated with the TDD mode of operation. The Pₘₐₓ value, in some aspects, may be a first Pₘₐₓ value, and the set of values may be a first set of values associated with a first cell and the report may include an additional set of values associated with a corresponding additional cell, and the additional set of values may include at least a second Pₘₐₓ value associated with the FD mode of operation at the UE. In some aspects, the set of values may include a PH value, at least one of the Pₘₐₓ value or the PH value may be a joint indication associated with both the FD mode of operation and a HD mode of operation at the UE. One of the Pₘₐₓ value or the PH value, in some aspects may include a single-mode indication associated with one of the FD mode of operation or the HD mode of operation at the UE, and the joint indication and the single-mode indication together indicate a first Pₘₐₓ value associated with the FD mode of operation at the UE, a second Pₘₐₓ value associated with the HD mode of operation at the UE, a first PH value associated with the FD mode of operation at the UE, and a second PH value associated with the HD mode of operation at the UE. In some aspects, the Pₘₐₓ value may be a first Pₘₐₓ value, and the set of values may include a first PH value associated with a HD mode of operation at the UE and a second Pₘₐₓ value associated with the HD mode of operation at the UE, and the set of values may include an additional value indicating whether a second PH associated with the FD mode of operation at the UE is within a threshold power of the first PH. The report, in some aspects, may be associated with one of a layer 2 (L2) signaling for reporting at least the Pₘₐₓ value associated with the FD mode of operation based on the SI measured at the UE or a layer 1 (L1) signaling for reporting at least the Pₘₐₓ value associated with the FD mode of operation based on the SI measured at the UE. In some aspects, the Pₘₐₓ may be based on a maximum power reduction for meeting a threshold power associated with the FD mode of operation.

In some aspects, the report may include a set of values including a first value indicating the first Pₘₐₓ and a second value indicating a second Pₘₐₓ associated with a half-duplex (HD) mode of operation at the UE. For example, 1406 may be performed by CU processor(s) 1612, DU processor(s) 1632, RU processor(s) 1642, transceiver(s) 1646, antenna(s) 1680, and/or dual mode PHR component 199 of FIG. 16. In some aspects, the set of values may include a third value indicating a power headroom (PH) associated with the HD mode of operation. The set of values, in some aspects, may include a fourth value indicating an additional PH associated with the FD mode of operation. In some aspects, the set of values may be associated with a slot configured for SBFD operation and the set of values may further include an indication of an active mode of operation at the UE, where the active mode of operation is the HD mode of operation. The set of values, in some aspects, may include a third value indicating a power headroom (PH) associated with an active mode of operation the active mode of operation is one of the FD mode of operation or the HD mode of operation. In some aspects, the set of values further may include a fifth value, where the fifth value indicates that the active mode of operation is the FD mode of operation or the fifth value indicates that the active mode of operation is the HD mode of operation. The set of values, in some aspects, may include a fifth value indicating a PH associated with a time division duplex (TDD) mode of operation and a sixth value indicating a Pₘₐₓ associated with the TDD mode of operation. In some aspects, the set of values may be a first set of values associated with a first cell and the report may further include an additional set of values associated with a corresponding additional cell, and where the additional set of values may include at least a third value indicating a third Pₘₐₓ associated with the FD mode of operation at the UE and a fourth value indicating a fourth Pₘₐₓ associated with the HD mode of operation at the UE. In some aspects, one of the first value and the second value may include a joint indication associated with both the FD mode of operation and the HD mode of operation, where one of the first value and the second value may include a single-mode indication associated with one of the FD mode of operation or the HD mode of operation, and where the joint indication and the single-mode indication together indicate the first Pₘₐₓ, the second Pₘₐₓ, a first power headroom (PH) associated with the FD mode of operation, and a second PH associated with the HD mode of operation. The set of values, in some aspects, may include a third value indicating a first power headroom (PH) associated with the half-duplex (HD) mode of operation at the UE, where the first value indicates may include an indication of whether a second PH associated with the FD mode of operation is within a threshold power of the first PH, where the first Pₘₐₓ is related to the second PH. In some aspects, the report includes a set of values including a first value associated with a maximum uplink power and a second value associated with a power headroom (PH), where one of the first value and the second value includes a joint indication associated with both the FD mode of operation and the HD mode of operation, where one of the first value and the second value includes a single-mode indication associated with one of the FD mode of operation or the HD mode of operation, and where the joint indication when combined with the single-mode indication indicate the first Pₘₐₓ and the second Pₘₐₓ and a first PH associated with the FD mode of operation and a second PH associated with the HD mode of operation. The report, in some aspects, may include a set of values including at least a first value indicating the second PH and a second value indicating whether the first PH is within a threshold power of the second PH. In some aspects, the report may include at least a first value indicating the first Pₘₐₓ, where the first Pₘₐₓ is based on at least one measure of self-interference. For example, referring to FIG. 10, the base station 1002 may receive transmit an indication 1020 of one or more of the Pₘₐₓ and PH.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize one or more antennas 1580 for communication. The cellular baseband processor(s) 1524 communicates through the transceiver(s) 1522 via the one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the dual mode PHR component 198 may be configured to receive configuration information associated with a report indicating a Pₘₐₓ associated with an FD mode of operation at the UE, and transmit, to a network device, the report, wherein the report comprises a set of values comprising a Pₘₐₓ value associated with the FD mode of operation at the UE. In some aspects, the dual mode PHR component 198 may be configured to receive configuration information associated with a report indicating a first Pₘₐₓ associated with an FD mode of operation at the UE, and transmit, to a network device, the report, wherein the report comprises a set of values comprising a first value indicating the first Pₘₐₓ and a second value indicating a second Pₘₐₓ associated with a HD mode of operation at the UE. In some aspects, the dual mode PHR component 198 may be configured to receive configuration information associated with a report indicating a first Pₘₐₓ associated with the FD mode of operation at the UE and a second Pₘₐₓ associated with a HD mode of operation at the UE, and transmit, to a network device, the report, wherein the report comprises a set of values comprising a first value associated with a maximum uplink power and a second value associated with a PH, wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. The dual mode PHR component 198, in some aspects, may be configured to receive configuration information associated with a report providing information regarding a first PH associated with the FD mode of operation at the UE and a second PH associated with a HD mode of operation at the UE, and transmit, to a network device, the report, wherein the report comprises a set of values comprising at least a first value indicating the second PH and a second value indicating whether the first PH is within a threshold power of the second PH. In some aspects, the dual mode PHR component 198 may be configured to receive configuration information associated with a report indicating at least a first Pₘₐₓ associated with the FD mode of operation at the UE, and transmit, to a network device, the report, wherein the report comprises at least a first value indicating the first Pₘₐₓ, wherein the first Pₘₐₓ is based on at least one measure of self-interference. The dual mode PHR component 198 may be within the cellular baseband processor(s) 1524, the application processor(s) 1506, or both the cellular baseband processor(s) 1524 and the application processor(s) 1506. The dual mode PHR component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving configuration information associated with a report indicating a maximum uplink power (Pₘₐₓ) associated with a full duplex (FD) mode of operation at the UE. The apparatus 1504, and in particular the cellular baseband processor(s) 1524 and/or the application processor(s) 1506, may include means for transmitting, to a network device, the report, wherein the report comprises a set of values comprising a Pₘₐₓ value associated with the FD mode of operation at the UE. The apparatus 1504, and in particular the cellular baseband processor(s) 1524 and/or the application processor(s) 1506, may include means for receiving configuration information associated with a report indicating a first maximum uplink power (Pₘₐₓ) associated with a full duplex (FD) mode of operation at the UE. The apparatus 1504, and in particular the cellular baseband processor(s) 1524 and/or the application processor(s) 1506, may include means for transmitting, to a network device, the report, wherein the report comprises a set of values comprising a first value indicating the first Pₘₐₓ and a second value indicating a second Pₘₐₓ associated with a half-duplex (HD) mode of operation at the UE. The apparatus 1504, and in particular the cellular baseband processor(s) 1524 and/or the application processor(s) 1506, may include means for measuring, based on the indication of the resources, the SI at the UE, wherein the set of values is based, at least in part, on the SI measured at the UE. The apparatus 1504, and in particular the cellular baseband processor(s) 1524 and/or the application processor(s) 1506, may include means for transmitting at least one of: a first indication of support for the report indicating the Pₘₐₓ and a second indication of support for measuring the SI during downlink reception, or a combined indication of support for the report indicating the Pₘₐₓ and support for measuring the SI during downlink reception. The apparatus 1504 may further include means for performing any of the aspects described in connection with the flowcharts in FIG. 11 or 12, and/or performed by the UE in the communication flow of FIG. 10. The means may be the dual mode PHR component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the dual mode PHR component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, one or more antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the dual mode PHR component 199 may be configured to transmit, to a UE that supports an FD mode of operation, configuration information associated with a report indicating a Pₘₐₓ associated with the FD mode of operation at the UE, and receive, from the UE, the report, wherein the report comprises a set of values comprising a Pₘₐₓ value associated with the FD mode of operation at the UE. n some aspects, the dual mode PHR component 199 may be configured to transmit, to a UE that supports an FD mode of operation, configuration information associated with a report indicating a first Pₘₐₓ associated with the FD mode of operation at the UE, and receive, from the UE, the report, wherein the report comprises a set of values comprising a first value indicating the first Pₘₐₓ and a second value indicating a second Pₘₐₓ associated with a HD mode of operation at the UE. In some aspects, the dual mode PHR component 199 may be configured to transmit, to a UE that supports an FD mode of operation, configuration information associated with a report indicating a first Pₘₐₓ associated with the FD mode of operation at the UE and a second Pₘₐₓ associated with a HD mode of operation at the UE, and receive, from the UE, the report, wherein the report comprises a set of values comprising a first value associated with a maximum uplink power and a second value associated with a PH, wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. The dual mode PHR component 199, in some aspects, may be configured to transmit, to a UE that supports an FD mode of operation, configuration information associated with a report providing information regarding a first PH associated with the FD mode of operation at the UE and a second PH associated with a HD mode of operation at the UE, and receive, from the UE, the report, wherein the report comprises a set of values comprising at least a first value indicating the second PH and a second value indicating whether the first PH is within a threshold power of the second PH. In some aspects, the dual mode PHR component 199 may be configured to transmit, to a UE that supports an FD mode of operation, configuration information associated with a report indicating at least a first Pₘₐₓ associated with the FD mode of operation at the UE, and receive, from the UE, the report, wherein the report comprises at least a first value indicating the first Pₘₐₓ, wherein the first Pₘₐₓ is based on at least one measure of self-interference. The dual mode PHR component 199 may be within one or more processors of one or more of the CU 1610, DU 1630, and the RU 1640. The dual mode PHR component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting, to a user equipment (UE) that supports a full-duplex (FD) mode of operation, configuration information associated with a report indicating a maximum uplink power (Pₘₐₓ) associated with the FD mode of operation at the UE. The network entity 1602, in some aspects, may include means for receiving, from the UE, the report, the report, wherein the report comprises a set of values comprising a Pₘₐₓ value associated with the FD mode of operation at the UE. The network entity 1602, in some aspects, may include means for transmitting, for a user equipment (UE) that supports a full-duplex (FD) mode of operation, configuration information associated with a report indicating a first maximum uplink power (Pₘₐₓ) associated with the FD mode of operation at the UE. The network entity 1602, in some aspects, may include means for receiving, from the UE, the report, wherein the report comprises a set of values comprising a first value indicating the first Pₘₐₓ and a second value indicating a second Pₘₐₓ associated with a half-duplex (HD) mode of operation at the UE. The network entity 1602, in some aspects, may include means for receiving, for the UE, at least one of: a first indication of support for the report indicating the Pₘₐₓ and a second indication of support for measuring the SI during downlink reception, or a combined indication of support for the report indicating the Pₘₐₓ and support for measuring the SI during the downlink reception. The network entity 1602 may further include means for performing any of the aspects described in connection with the flowchart in FIGS. 13 and 14, and/or performed by the base station in the communication flow of FIG. 10. The means may be the dual mode PHR component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to extending a PHR or P_{cmax} reporting for a UE (e.g., a SBFD-capable UE) that supports operation in different HD modes of operation (e.g., associated with TDD or SBFD slots and/or symbols) or an FD mode of operation (e.g., associated with SBFD slots and/or symbols). Some aspects more specifically relate to new formats and/or configurations for signaling associated with PHR or P_{cmax} reporting including an indication of a PH or P_{cmax} (where P_{cmax} may be referred to as Pₘₐₓ for simplicity) for each of a HD mode of operation and a SBFD mode of operation at the UE. In some examples, a wireless device may be configured to receive configuration information associated with a report indicating a Pₘₐₓ associated with an FD mode of operation at the UE, and transmit, to a network device, the report, wherein the report comprises a set of values comprising a Pₘₐₓ value associated with the FD mode of operation at the UE. In some examples, a network device may be configured to transmit, to a UE that supports an FD mode of operation, configuration information associated with a report indicating a Pₘₐₓ associated with the FD mode of operation at the UE, and receive, from the UE, the report, wherein the report comprises a set of values comprising a Pₘₐₓ value associated with the FD mode of operation at the UE. In some examples, a wireless device may be configured to receive configuration information associated with a report indicating a first Pₘₐₓ associated with the FD mode of operation at the UE and a second Pₘₐₓ associated with a HD mode of operation at the UE, and transmit, to a network device, the report, wherein the report comprises a set of values comprising a first value associated with a maximum uplink power and a second value associated with a power headroom (PH), wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. In some examples, a wireless device may be configured to receive configuration information associated with a report providing information regarding a first power headroom (PH) associated with the FD mode of operation at the UE and a second PH associated with a half-duplex (HD) mode of operation at the UE, and transmit, to a network device, the report, wherein the report comprises a set of values comprising at least a first value indicating the second PH and a second value indicating whether the first PH is within a threshold power of the second PH. In some examples, a wireless device may be configured to receive configuration information associated with a report indicating at least a first Pₘₐₓ associated with the FD mode of operation at the UE, and transmit, to a network device, the report, wherein the report comprises at least a first value indicating the first Pₘₐₓ, wherein the first Pₘₐₓ is based on at least one measure of self-interference. In some examples, a network device may be configured to transmit, to a UE that supports an FD mode of operation, configuration information associated with a report indicating a first Pₘₐₓ associated with the FD mode of operation at the UE and a second Pₘₐₓ associated with a HD mode of operation at the UE, and receive, from the UE, the report, wherein the report comprises a set of values comprising a first value associated with a maximum uplink power and a second value associated with a PH, wherein one of the first value and the second value comprises a joint indication associated with both the FD mode of operation and the HD mode of operation, wherein one of the first value and the second value comprises a single-mode indication associated with one of the FD mode of operation or the HD mode of operation, and wherein the joint indication when combined with the single-mode indication indicate the first Pₘₐₓ and the second Pₘₐₓ and a first PH associated with the FD mode of operation and a second PH associated with the HD mode of operation. In some examples, a network device may be configured to transmit, to a UE that supports an FD mode of operation, configuration information associated with a report providing information regarding a first PH associated with the FD mode of operation at the UE and a second PH associated with a HD mode of operation at the UE, and receive, from the UE, the report, wherein the report comprises a set of values comprising at least a first value indicating the second PH and a second value indicating whether the first PH is within a threshold power of the second PH. In some examples, a network device may be configured to transmit, to a UE that supports an FD mode of operation, configuration information associated with a report indicating at least a first Pₘₐₓ associated with the FD mode of operation at the UE, and receive, from the UE, the report, wherein the report comprises at least a first value indicating the first Pₘₐₓ, wherein the first Pₘₐₓ is based on at least one measure of self-interference.

Particular aspects of the subject matter described in this disclosure can be implemented to realize one or more of the following potential advantages. In some examples, by indicating the PH or P_{cmax} for each of the HD mode of operation and the SBFD mode of operation at an SBFD-capable UE, the described techniques can be used to perform power control for the SBFD-capable UE that accounts for interference (e.g., SI or SI and external interference) experienced at the SBFD-capable UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving configuration information associated with a report indicating a maximum uplink power (Pₘₐₓ) associated with a full duplex (FD) mode of operation at the UE; and transmitting, to a network device, the report, wherein the report comprises a set of values comprising a Pₘₐₓ value associated with the FD mode of operation at the UE.

Aspect 2 is the method of aspect 1, wherein the set of values comprises a power headroom (PH) value associated with the FD mode of operation at the UE.

Aspect 3 is the method of aspect 2, wherein the report comprises a single-bit indication that the PH value is associated with the FD mode of operation at the UE.

Aspect 4 is the method of any of aspects 1 to 3, wherein the Pₘₐₓ value is a first Pₘₐₓ value, wherein the set of values comprises a second Pₘₐₓ value associated with a half-duplex (HD) mode of operation at the UE and a power headroom (PH) value associated with the HD mode of operation.

Aspect 5 is the method of aspect 4, wherein the report comprises a single-bit indication that the PH value is associated with the HD mode of operation at the UE.

Aspect 6 is the method of aspect 5, wherein the set of values further comprises an additional indication that the first Pₘₐₓ value is included in the set of values.

Aspect 7 is the method of any of aspects 1 to 6, wherein the set of values is associated with a slot configured for SBFD operation and the set of values further comprises an indication of an active mode of operation at the UE.

Aspect 8 is the method of any of aspects 1 to 7, wherein the Pₘₐₓ value is a first Pₘₐₓ value, wherein the configuration information further indicates whether: the set of values includes a single power headroom (PH) value associated with one of a half-duplex (HD) mode of operation at the UE or the FD mode of operation at the UE; or the set of values includes a first PH value associated with the HD mode of operation, a second Pₘₐₓ value associated with the HD mode of operation at the UE, and a second PH value associated with the FD mode of operation.

Aspect 9 is the method of aspect 8, wherein the configuration information further indicates whether the set of values includes a third PH value associated with a time division duplex (TDD) mode of operation and a third Pₘₐₓ value associated with the TDD mode of operation.

Aspect 10 is the method of any of aspects 1 to 9, wherein the Pₘₐₓ value is a first Pₘₐₓ value, wherein the set of values is a first set of values associated with a first cell and the report further comprises an additional set of values associated with a corresponding additional cell, and wherein the additional set of values comprises at least a second Pₘₐₓ value associated with the FD mode of operation at the UE.

Aspect 11 is the method of aspect 1, wherein the set of values comprises a power headroom (PH) value, wherein at least one of the Pₘₐₓ value or the PH value comprises a joint indication associated with both the FD mode of operation and a half-duplex (HD) mode of operation at the UE.

Aspect 12 is the method of aspect 11, wherein one of the Pₘₐₓ value or the PH value comprises a single-mode indication associated with one of the FD mode of operation or the HD mode of operation at the UE, and wherein the joint indication and the single-mode indication together indicate a first Pₘₐₓ value associated with the FD mode of operation at the UE, a second Pₘₐₓ value associated with the HD mode of operation at the UE, a first PH value associated with the FD mode of operation at the UE, and a second PH value associated with the HD mode of operation at the UE.

Aspect 13 is the method of aspect 1, wherein the Pₘₐₓ value is a first Pₘₐₓ value, and wherein the set of values comprises a first power headroom (PH) value associated with a half-duplex (HD) mode of operation at the UE and a second Pₘₐₓ value associated with the HD mode of operation at the UE, wherein the set of values comprises an additional value indicating whether a second PH associated with the FD mode of operation at the UE is within a threshold power of the first PH.

Aspect 14 is the method of any of aspects 1 to 13, wherein the configuration information further comprises an indication of resources for measuring a self-interference (SI) at the UE, the method further comprising: measuring, based on the indication of the resources, the SI at the UE, wherein the set of values is based, at least in part, on the SI measured at the UE.

Aspect 15 is the method of aspect 14, wherein the report is associated with one of: a layer 2 (L2) signaling for reporting at least the Pₘₐₓ value associated with the FD mode of operation based on the SI measured at the UE; or a layer 1 (L1) signaling for reporting at least the Pₘₐₓ value associated with the FD mode of operation based on the SI measured at the UE.

Aspect 16 is the method of any of aspects 14 and 15, wherein the resources are further for measuring a combination of cross link interference (CLI) and the SI.

Aspect 17 is the method of aspect 16, wherein the resources for measuring the SI comprise a first set of measurement resources that overlap in both time and frequency with a first uplink transmission from the UE for measuring the SI and a second set of measurement resources that do not overlap in both time and frequency with any uplink transmission from the UE for measurement of inter-cell interference.

Aspect 18 is the method of aspect 17, wherein the first uplink transmission is one of a reference signal transmission or a dummy transmission scheduled to overlap with the first set of measurement resources.

Aspect 19 is the method of aspect 18, wherein the first set of measurement resources and the first uplink transmission overlap with the second set of measurement resources in time and do not overlap with the second set of measurement resources in frequency.

Aspect 20 is the method of any of aspects 14 to 19, further comprising transmitting at least one of: a first indication of support for the report indicating the Pₘₐₓ associated with the FD mode of operation and a second indication of support for measuring the SI during downlink reception; or a combined indication of support for the report indicating the Pₘₐₓ and support for measuring the SI during the downlink reception.

Aspect 21 is the method of any of aspects 1 to 20, wherein the Pₘₐₓ is based on a maximum power reduction for meeting a threshold power associated with the FD mode of operation.

Aspect 22 is a method of wireless communication at a network device, comprising: transmitting, to a user equipment (UE) that supports a full-duplex (FD) mode of operation, configuration information associated with a report indicating a maximum uplink power (Pₘₐₓ) associated with the FD mode of operation at the UE; and receiving, from the UE, the report, wherein the report comprises a set of values comprising a Pₘₐₓ value associated with the FD mode of operation at the UE.

Aspect 23 is the method of aspect 22, wherein the set of values comprises a power headroom (PH) value associated with the FD mode of operation at the UE.

Aspect 24 is the method of aspect 23, wherein the report comprises a single-bit indication that the PH value is associated with the FD mode of operation at the UE.

Aspect 25 is the method of any of aspects 22-24, wherein the Pₘₐₓ value is a first Pₘₐₓ value, wherein the set of values comprises a second Pₘₐₓ value associated with a half-duplex (HD) mode of operation at the UE and a power headroom (PH) value associated with the HD mode of operation.

Aspect 26 is the method of aspect 25, wherein the report comprises a single-bit indication that the PH value is associated with the HD mode of operation at the UE.

Aspect 27 is the method of aspect 26, wherein the set of values further comprises an additional indication that the first Pₘₐₓ value is included in the set of values.

Aspect 28 is the method of any of aspects 22 to 27, wherein the set of values is associated with a slot configured for SBFD operation and the set of values further comprises an indication of an active mode of operation at the UE.

Aspect 29 is the method of any of aspects 22 to 28, wherein the Pₘₐₓ value is a first Pₘₐₓ value, wherein the configuration information further indicates whether: the set of values includes a single power headroom (PH) value associated with one of a half-duplex (HD) mode of operation at the UE or the FD mode of operation at the UE; or the set of values includes a first PH value associated with the HD mode of operation, a second Pₘₐₓ value associated with the HD mode of operation at the UE, and a second PH value associated with the FD mode of operation.

Aspect 30 is the method of aspect 29, wherein the configuration information further indicates whether the set of values includes a third PH value associated with a time division duplex (TDD) mode of operation and a third Pₘₐₓ value associated with the TDD mode of operation.

Aspect 31 is the method of any of aspects 22 to 30, wherein the Pₘₐₓ value is a first Pₘₐₓ value, wherein the set of values is a first set of values associated with a first cell and the report further comprises an additional set of values associated with a corresponding additional cell, and wherein the additional set of values comprises at least a second Pₘₐₓ value associated with the FD mode of operation at the UE.

Aspect 32 is the method of aspect 22, wherein the set of values comprises a power headroom (PH) value, wherein at least one of the Pₘₐₓ value or the PH value comprises a joint indication associated with both the FD mode of operation and a half-duplex (HD) mode of operation at the UE.

Aspect 33 is the method of aspect 32, wherein one of the Pₘₐₓ value or the PH value comprises a single-mode indication associated with one of the FD mode of operation or the HD mode of operation at the UE, and wherein the joint indication and the single-mode indication together indicate a first Pₘₐₓ value associated with the FD mode of operation at the UE, a second Pₘₐₓ value associated with the HD mode of operation at the UE, a first PH value associated with the FD mode of operation at the UE, and a second PH value associated with the HD mode of operation at the UE.

Aspect 34 is the method of aspect 22, wherein the Pₘₐₓ value is a first Pₘₐₓ value, and wherein the set of values comprises a first power headroom (PH) value associated with a half-duplex (HD) mode of operation at the UE and a second Pₘₐₓ value associated with the HD mode of operation at the UE, wherein the set of values comprises an additional value indicating whether a second PH associated with the FD mode of operation at the UE is within a threshold power of the first PH.

Aspect 35 is the method of any of aspects 22 to 34, wherein the configuration information further comprises an indication of resources for measuring a self-interference (SI) at the UE, wherein the set of values indicates the SI.

Aspect 36 is the method of aspect 35, wherein the report is associated with one of: a layer 2 (L2) signaling for reporting at least the Pₘₐₓ value associated with the FD mode of operation based on the SI measured at the UE; or a layer 1 (L1) signaling for reporting at least the Pₘₐₓ value associated with the FD mode of operation based on the SI measured at the UE.

Aspect 37 is the method of any of aspects 35 and 36, wherein the resources are further for measuring a combination of cross link interference (CLI) and the SI.

Aspect 38 is the method of aspect 37, wherein the resources for measuring the SI comprise a first set of measurement resources that overlap in both time and frequency with a first uplink transmission from the UE for measuring the SI and a second set of measurement resources that do not overlap in both time and frequency with any uplink transmission from the UE for measurement of inter-cell interference.

Aspect 39 is the method of aspect 38, wherein the first uplink transmission is one of a reference signal transmission or a dummy transmission scheduled to overlap with the first set of measurement resources.

Aspect 40 is the method of aspect 39, wherein the first set of measurement resources and the first uplink transmission overlap with the second set of measurement resources in time and do not overlap with the second set of measurement resources in frequency.

Aspect 41 is the method of any of aspects 35 to 40, further comprising receiving, from the UE, at least one of: a first indication of support for the report indicating the Pₘₐₓ and a second indication of support for measuring the SI during downlink reception; or a combined indication of support for the report indicating the first Pₘₐₓ and support for measuring the SI during the downlink reception.

Aspect 42 is the method of any of aspects 22 to 41, wherein the Pₘₐₓ is based on a maximum power reduction for meeting a threshold power associated with the FD mode of operation.

Aspect 43 is an apparatus for wireless communication at a UE, comprising: at least one memory; and at least one processor coupled to the at least one memory, the at least one processor is configured to perform the method of any of aspects 1 to 21.

Aspect 44 is an apparatus for wireless communication at a UE, comprising means for performing each step in the method of any of aspects 1 to 21.

Aspect 45 is the apparatus of any of aspects 43 to 44, further comprising a transceiver configured to receive or to transmit in association with the method of any of aspects 1 to 21.

Aspect 46 is a computer-readable medium storing computer executable code at a UE, the code when executed by at least one processor causes the at least one processor to perform the method of any of aspects 1 to 21.

Aspect 47 is an apparatus for wireless communication at a network device, comprising: at least one memory; and at least one processor coupled to the at least one memory, the at least one processor is configured to perform the method of any of aspects 22 to 42.

Aspect 48 is an apparatus for wireless communication at a network device, comprising means for performing each step in the method of any of aspects 22 to 42.

Aspect 49 is the apparatus of any of aspects 47 to 48, further comprising a transceiver configured to receive or to transmit in association with the method of any of aspects 22 to 42.

Aspect 50 is a computer-readable medium storing computer executable code at a network device, the code when executed by at least one processor causes the at least one processor to perform the method of any of aspects 22 to 42.

What is claimed is:

1. An apparatus of wireless communication at a user equipment (UE), comprising:
at least one memory; and
at least one processor coupled to the at least one memory and, based at least in part on information stored in the at least one memory, the at least one processor is configured to:
receive configuration information associated with a report indicating a maximum uplink power (Pₘₐₓ) associated with a full duplex (FD) mode of operation at the UE; and
transmit, to a network device, the report, wherein the report comprises a set of values comprising a Pₘₐₓ value associated with the FD mode of operation at the UE.

2. The apparatus of claim 1, wherein the set of values comprises a power headroom (PH) value associated with the FD mode of operation at the UE.

3. The apparatus of claim 2, wherein the report comprises a single-bit indication that the PH value is associated with the FD mode of operation at the UE.

4. The apparatus of claim 1, wherein the Pₘₐₓ value is a first Pₘₐₓ value, wherein the set of values comprises a second Pₘₐₓ value associated with a half-duplex (HD) mode of operation at the UE and a power headroom (PH) value associated with the HD mode of operation.

5. The apparatus of claim 4, wherein the report comprises a single-bit indication that the PH value is associated with the HD mode of operation at the UE.

6. The apparatus of claim 5, wherein the set of values further comprises an additional indication that the first Pₘₐₓ value is included in the set of values.

7. The apparatus of claim 1, wherein the set of values is associated with a slot configured for SBFD operation and the set of values further comprises an indication of an active mode of operation at the UE.

8. The apparatus of claim 1, wherein the Pₘₐₓ value is a first Pₘₐₓ value, wherein the configuration information further indicates whether:
the set of values includes a single power headroom (PH) value associated with one of a half-duplex (HD) mode of operation at the UE or the FD mode of operation at the UE; or
the set of values includes a first PH value associated with the HD mode of operation, a second Pₘₐₓ value associated with the HD mode of operation at the UE, and a second PH value associated with the FD mode of operation.

9. The apparatus of claim 8, wherein the configuration information further indicates whether the set of values includes a third PH value associated with a time division duplex (TDD) mode of operation and a third Pₘₐₓ value associated with the TDD mode of operation.

10. The apparatus of claim 1, wherein the Pₘₐₓ value is a first Pₘₐₓ value, wherein the set of values is a first set of values associated with a first cell and the report further comprises an additional set of values associated with a corresponding additional cell, and wherein the additional set of values comprises at least a second Pₘₐₓ value associated with the FD mode of operation at the UE.

11. The apparatus of claim 1, wherein the set of values comprises a power headroom (PH) value, wherein at least one of the Pₘₐₓ value or the PH value comprises a joint indication associated with both the FD mode of operation and a half-duplex (HD) mode of operation at the UE, and wherein one of the Pₘₐₓ value or the PH value comprises a single-mode indication associated with one of the FD mode of operation or the HD mode of operation at the UE, and wherein the joint indication and the single-mode indication together indicate a first Pₘₐₓ value associated with the FD mode of operation at the UE, a second Pₘₐₓ value associated with the HD mode of operation at the UE, a first PH value associated with the FD mode of operation at the UE, and a second PH value associated with the HD mode of operation at the UE.

12. The apparatus of claim 1, wherein the Pₘₐₓ value is a first Pₘₐₓ value, and wherein the set of values comprises a first power headroom (PH) value associated with a half-duplex (HD) mode of operation at the UE and a second Pₘₐₓ value associated with the HD mode of operation at the UE, wherein the set of values comprises an additional value indicating whether a second PH associated with the FD mode of operation at the UE is within a threshold power of the first PH.

13. The apparatus of claim 1, wherein the configuration information further comprises an indication of resources for measuring a self-interference (SI) at the UE, wherein the at least one processor is further configured to:
measure, based on the indication of the resources, the SI at the UE, wherein the set of values is based, at least in part, on the SI measured at the UE.

14. The apparatus of claim 13, wherein the report is associated with one of:
a layer 2 (L2) signaling for reporting at least the Pₘₐₓ value associated with the FD mode of operation based on the SI measured at the UE; or
a layer 1 (L1) signaling for reporting at least the Pₘₐₓ value associated with the FD mode of operation based on the SI measured at the UE.

15. The apparatus of claim 13, wherein the resources are further for measuring a combination of cross link interference (CLI) and the SI.

16. The apparatus of claim 15, wherein the resources for measuring the SI comprise a first set of measurement resources that overlap in both time and frequency with a first uplink transmission from the UE for measuring the SI and a second set of measurement resources that do not overlap in both time and frequency with any uplink transmission from the UE for measurement of inter-cell interference.

17. The apparatus of claim 13, further comprising a transceiver coupled to the at least one processor, wherein the at least one processor is further configured to transmit, via the transceiver, at least one of:
a first indication of support for the report indicating the Pₘₐₓ associated with the FD mode of operation and a second indication of support for measuring the SI during downlink reception; or
a combined indication of support for the report indicating the Pₘₐₓ and support for measuring the SI during the downlink reception.

18. The apparatus of claim 1, wherein the Pₘₐₓ is based on a maximum power reduction for meeting a threshold power associated with the FD mode of operation.

19. A method of wireless communication at a user equipment (UE), comprising:
receiving configuration information associated with a report indicating a maximum uplink power (Pₘₐₓ) associated with a full duplex (FD) mode of operation at the UE; and
transmitting, to a network device, the report, wherein the report comprises a set of values comprising a Pₘₐₓ value associated with the FD mode of operation at the UE.

20. A method of wireless communication at a network device, comprising:
transmitting, to a user equipment (UE) that supports a full-duplex (FD) mode of operation, configuration information associated with a report indicating a maximum uplink power (Pₘₐₓ) associated with the FD mode of operation at the UE; and
receiving, from the UE, the report, wherein the report comprises a set of values comprising a Pₘₐₓ value associated with the FD mode of operation at the UE.
